(19) United States
(12) Patent Application Publication
(10) Pub. No.: US 2025/0091962 A1
(43) Pub. Date: Mar. 20, 2025

(54) ACTIVE CURING SYSTEMS AND METHODS FOR CONCRETE MANUFACTURING BY CARBON DIOXIDE SEQUESTRATION

(71) Applicants: The Regents of the University of California, Oakland, CA (US); CarbonBuilt, Inc., EI Segundo, CA (US)

(72) Inventors: Iman MEHDIPOUR, Los Angeles, CA (US); Gaurav SANT, Los Angeles, CA (US); Dale P. PRENTICE, Los Angeles, CA (US); Dante SIMONETTI, Los Angeles, CA (US); Panagiotis D. CHRISTOFIDES, Los Angeles, CA (US)

(21) Appl. No.: 18/962,767

(22) Filed: Nov. 27, 2024

Related U.S. Application Data
(63) Continuation of application No. PCT/US2023/024217, filed on Jun. 1, 2023.
(60) Provisional application No. 63/365,763, filed on Jun. 2, 2022.

(51) Int. Cl. C04B 40/02; B28B 11/24

(52) U.S. Cl. CPC C04B 40/0231; B28B 11/245; C04B 40/0263; C04B 40/0281

(57) ABSTRACT

Provided herein are active flow-through carbonation curing systems useful for contacting carbon dioxide (CO₂) gas streams with concrete materials under ambient pressure. This contacting causes a carbonation reaction in which CO₂ forms materials, such as, but not limited to, calcium carbonate (CaCO₃). The methods include, but are not limited to, contacting a conditioned flue gas containing CO₂ inside of a carbonation chamber with green bodies or concrete components in which flue gas properties such as temperature, relative humidity, flow rate, and flow direction, are self-adjusted during the curing process based on a self-sensing instrumentation system inside a curing chamber and carbonation kinetic regression model. This system improves CO₂ capture efficiency and material performance while reducing processing energy.

### CROSS-REFERENCE TO RELATED APPLICATIONS

The application is a continuation application of International Patent Application No. PCT/US2023/024217, filed Jun. 4, 2023, which claims priority to, and the benefit of, U.S. Provisional Patent Application No. 63/365,763, filed Jun. 2, 2023, and entitled “Active Curing Systems and Methods for Concrete Manufacturing by Carbon Dioxide Sequestration”, the entire contents of all which are herein incorporated by reference in its entirety for all purposes.

### FIELD

The present disclosure concerns carbon dioxide (CO₂) mineralization and a system for active flow-through carbonation curing system of concrete, as well as methods of manufacturing carbonated concrete components.

### BACKGROUND

Industrial CO₂ production is an environmental concern. For example, the manufacture of the cement binder for concrete accounts for 5% of global CO₂ emissions from all industrial process and fossil-fuel combustion in 2013. Greenhouse gases such as CO₂ absorb solar energy—the so-called Greenhouse Effect and result in climate change events. Rising levels of carbon dioxide in the atmosphere have been associated with global warming.

What is needed are processes for using CO₂ gas streams (e.g., direct air capture or industrial flue gas streams) to make useful products and also reduce the total production of CO₂. The current carbonation curing chambers are primarily designed in a closed loop process control in which curing chambers are filled with CO₂-containing gas and pressurized. To enhance carbonation kinetics, such curing systems require a separate drying step and/or external heating systems such as heating jackets to evaporate water from the concrete and in order to improve gas transport. Such processing conditions result in longer/extended curing cycles and larger system process energy demand.

### SUMMARY

This disclosure sets forth an active flow-through carbonation chamber system in which gas processing conditions are self-adjusted based on self-sensing instrumentation system and control schemes inside the chamber to optimize system energy demand while improving CO₂ sequestration efficiency and concrete performance. The flow-through and self-sensing nature (active system) of the carbonation curing system allows for a shortened carbonation curing cycle and reduces the system energy demand as compared to passive curing systems in which processing conditions are constant during curing time.

In certain embodiments, set forth herein is an active carbonation curing apparatus comprising: a flow-through chamber at ambient pressure; and a gas conditioning apparatus comprising at least one heat exchanger, at least one blower, and at least one chiller; wherein: the gas conditioning apparatus is configured to condition a CO₂-containing gas stream that flows from the gas conditioning apparatus to the flow-through chamber; and wherein: the flow-through chamber comprises at least one self-sensing instrumentation system, comprising sensors to measure the temperature in the carbonation chamber, humidity, gas velocity, or combinations thereof; the flow-through chamber comprises at least one green body or at least one concrete component, or both, with a sensor coupled thereto to measure the green body's, or the concrete component's, temperature and humidity, and mass change; the flow-through chamber comprises at least one gas flow piping system and remote damper control with a sensor coupled thereto to control gas flow direction in the curing chamber; the gas conditioning apparatus is configured to actively adjust CO₂-containing gas properties selected from temperature, relative humidity, gas flow rate, and combinations thereof.

In other embodiments, set forth herein is a carbonation process, comprising: providing an active carbonation curing apparatus comprising: a flow-through chamber at ambient pressure and comprising at least one green body or at least one concrete component, or both; and a gas conditioning apparatus coupled to the flow-through chamber and configured to actively condition a CO₂-containing gas stream; measuring the temperature in the carbonation chamber, humidity, and gas velocity in the flow-through chamber; measuring temperature, humidity, mass change, or a combination thereof in the at least one green body or at least one concrete component, or both; using the gas conditioning apparatus to actively adjust the temperature, relative humidity, flow rate, CO₂ concentration, or a combination thereof, in the CO₂-containing gas stream to provide a conditioned gas; and contacting the conditioned gas with the at least one green body or at least one concrete component, or both in the flow-through chamber.

In other embodiments, set forth herein is a process comprising: flowing a CO₂-containing gas from a gas conditioning apparatus into a carbonation chamber comprising at least one green body; measuring, in real-time, temperature, relative humidity, CO₂ concentration, gas flow rate, gas flow direction, or a combination thereof, in the carbonation chamber to provide a measurement; inputting the measurement into a regression model to determine the extent of carbonation of the at least one green body; sending a control signal to the gas conditioning apparatus while flowing the CO₂-containing gas to: actively condition the CO₂-containing gas based on the extent of carbonation; and effect a multi-step carbonation process.

In yet other embodiments, set forth herein is a system comprising: a gas conditioning apparatus; a flow-through chamber; and an instrument configured to send control signals to the gas conditioning apparatus wherein the flow-through chamber is at atmospheric pressure and comprises; a processor and a storage medium with instructions operable when executed for flowing a CO₂-containing gas from a gas conditioning apparatus into a carbonation chamber comprising at least one green body; measuring, in real-time, temperature, relative humidity, CO₂ concentration, gas flow rate, gas flow direction, or a combination thereof, in the carbonation chamber to provide a measurement; inputting the measurement into a regression model to determine the extent of carbonation of the at least one green body; sending a control signal to the gas conditioning apparatus while flowing the CO₂-containing gas to: actively condition the CO₂-containing gas based on the extent of carbonation; and effect a multi-step carbonation process.

The manufacturing processes set forth herein are versatile and can be used to produce a variety of precast concrete or concrete masonry products of different geometries and shapes.

### BRIEF DESCRIPTIONS OF THE DRAWINGS

FIG. 1A shows a three-dimensional model of the carbonation curing system used in Example 1. FIG. 1B shows a closer model view of the curing chamber in the carbonation curing system including concrete component arrangement. FIGS. 1C-1G show a self-sensing instrumental system inside of the curing chamber to monitor temperature, relative humidity of chamber environment, gas velocity, and temperature, relative humidity and mass change of concrete during carbonation curing period and temperature, relative humidity, and flow rate of gas at inlet and outlet of curing chamber.

FIG. 2 shows a process flow diagram for the carbonation curing system used in Example 1. FIG. 2 shows how the carbonation curing system sequesters CO₂ in concrete.

FIG. 3A, 3B shows cumulative CO₂ input into the system, cumulative CO₂ uptake into the carbonated concrete blocks, and CO₂ utilization efficiency as a function of 24-h carbonation for two-step drying-carbonation processing and optimized single step carbonation processing. FIG. 3C System process energy usage per unit CO₂ uptake for two-step drying-carbonation and single-step carbonation curing. FIG. 3D Compressive strength of carbonated concrete products for two-step drying-carbonation and single-step carbonation curing.

FIG. 4A shows temperature profile of CO₂-containing gas streams at inlet and outlet of curing chamber under constant curing processing conditions (i.e., passive system) during the 24-h carbonation curing. FIG. 4B shows temperature profile of CO₂-containing gas streams at inlet and outlet of curing chamber under variable/adjusted processing conditions (active system) during the 18-h carbonation curing for active curing system. FIG. 4C temperature evolution profiles of concrete and curing chamber environment during the carbonation curing process. The internal temperature and relative humidity of concrete are monitored as a means to control processing conditions during carbonation curing. FIGS. 4D and 4E show system energy usage per unit CO₂ uptake and compressive strength of carbonated concretes for passive and active curing systems.

FIG. 5 shows the effect of chiller outlet temperature on system utilities and system process energy as determined using modeling simulations.

FIG. 6A shows plots of linear drying shrinkage for carbonated concrete blocks that were cured under ambient pressure and using coal-fired flue gas stream using active curing system. FIG. 6B shows plots of freeze-thaw durability for carbonated concrete blocks that were cured under ambient pressure and using coal-fired flue gas stream using active curing system.

FIG. 7A shows gauge plugs in concrete components. FIG. 7B shows stress-strain curves for carbonated concrete blocks that were cured under ambient pressure and using a coal-fired flue gas stream using active curing system.

FIG. 8 shows a schematic of the CO₂ mineralization process. The CO₂-containing stream is humidified using the gas wash bottles and streamed into the flow-through carbonation reactor. The temperature (T), relative humidity (RH) and CO₂ concentration within the reactor are monitored in real-time using computer-linked sensors.

FIG. 9 shows carbonation data of the Type-III cement studied at 25, 50 and 65° C. considering the mass fractions of C—S—H, portlandite and ettringite formation as a degree of hydration determined from thermodynamic modeling and the accompanying maximum theoretical CO₂ uptake at 25° C.

FIG. 10 shows heat duty requirements for the chiller considering variations of: (a) [CO₂] and [H₂O] of flue gas at various flue gas inlet temperatures, (b) [H₂O] and temperature for various [CO₂], and heat duty requirements for the heater considering variations of: (c) [CO₂] and [H₂O] of at various flue gas inlet temperatures, and (d) [H₂O] and temperature for various [CO₂] contents.

FIG. 11 shows uptake efficiency of the system considering impact of flue gas conditions with variable [H₂O] and temperature for [CO₂] of a) 2 v./v.%, b) 7.5 v./v.% and c) 15 v./v.%.

FIG. 12 shows the energy intensity of CO₂ uptake considering the impact of [CO₂] and [H₂O] at flue gas inlet conditions of a) 25° C., b) 50, and c) 70° C.

### DETAILED DESCRIPTION

### Definitions

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is circular can refer to a diameter of the object. In the case of an object that is non-circular, a size of the non-circular object can refer to a diameter of a corresponding circular object, where the corresponding circular object exhibits or has a particular set of derivable or measurable characteristics that are substantially the same as those of the non-circular object. Alternatively, or in conjunction, a size of a non-circular object can refer to an average of various orthogonal dimensions of the object. Thus, for example, a size of an object that is an ellipse can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

As used herein, the term “active carbonation” refers to a self-adjusting curing system based on self-sensing instrumentation system in the curing chamber which adjusts gas processing conditions to enhance a carbonation reaction rate that is above a natural value while reducing system energy demand. For example, a carbonation rate at or above 0.005 per hour is a non-limiting example of active carbonation. The self-sensing instrumentation system includes real-time sensors to measure temperature, relative humidity, CO₂ concentration, flow rate, flow direction, or a combination thereof, in the carbonation chamber.

As used herein, the term “flow-through chamber” refers to a chamber through which gas may be flowed continuously in an open loop system and at ambient pressure.

As used herein, the term “ambient pressure” refers to atmospheric pressure on planet Earth, and with reference to the processes and apparatuses described herein, particularly to the atmospheric pressure at that location.

As used herein, the term “gas conditioning apparatus” refers to a system which is configured to receive a CO₂-containing gas and adjust the temperature, relative humidity, flow rate, or a combination thereof, of the CO₂-containing gas before flowing the CO₂-containing gas out of the gas conditioning apparatus. A gas conditioning apparatus may include more than one heater, chiller, fans, blowers, filters, or a combination thereof.

As used herein, the term “coupled to” refers to an electrical, digital, mechanical, wireless, Bluetooth, or other operable connection between one or more apparatuses.

As used herein, the term “CO₂-containing flue gas stream” refers to a gas stream effluent from a source other than the atmosphere and which includes carbon dioxide (CO₂).

As used herein, the term “CO₂-containing gas” refers to any gas stream that includes carbon dioxide (CO₂).

As used herein, the term “conditioned CO₂-containing gas stream” or “conditioned gas” refers to a CO₂-containing gas stream which has had its temperature, relative humidity, flow rate, or a combination thereof, adjusted or modified relative to an initial condition in which the CO₂-containing gas stream had a different temperature, relative humidity, flow rate, or a combination thereof.

As used herein, the term “air curing” refers to drying to adjust moisture content of concrete prior to carbonation curing process.

As used herein the term “active conditioning,” refers to a process in which the conditions in the carbonation chamber are changed by changing the properties of the CO₂-containing gas flowing into the carbonation chamber. In order to achieve product uniformity, and energy savings, a CO₂-containing gas may be conditioned, for example, by having its flow rate or flow direction changed as it moves into and through the carbonation chamber. In order to achieve product uniformity, and energy savings, a CO₂-containing gas may be conditioned, for example, by having its temperature increased or decreased. Conditioning is accomplished using a gas conditioning apparatus. The gas conditioning apparatus is controlled by control signals that are based on real-time measurements occurring in the carbonation chamber. The control signals are, in some embodiments, also based on a previously acquired regression model which correlates properties measured in the carbonation chamber with the extent of carbonation (e.g., amount of CaCO₃ formed) and/or the rate of carbonation.

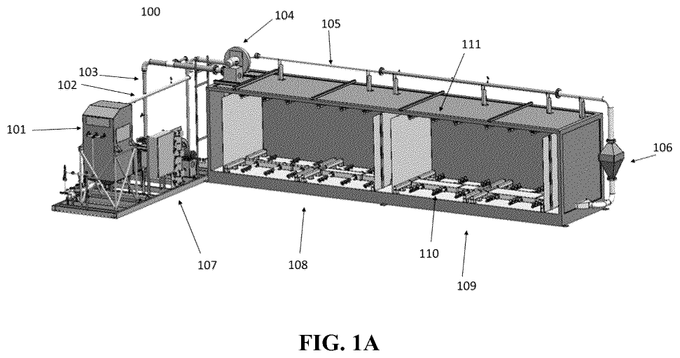

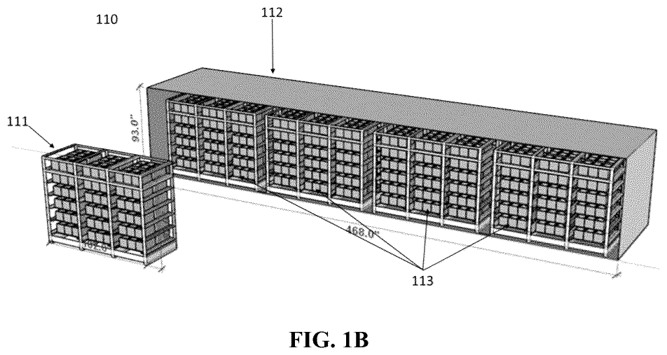

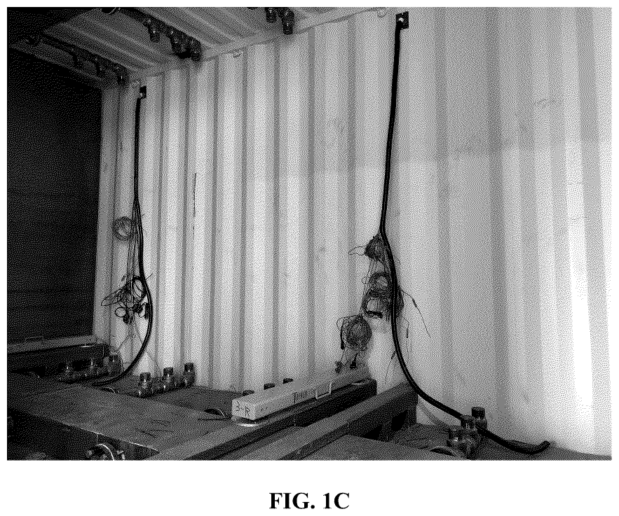

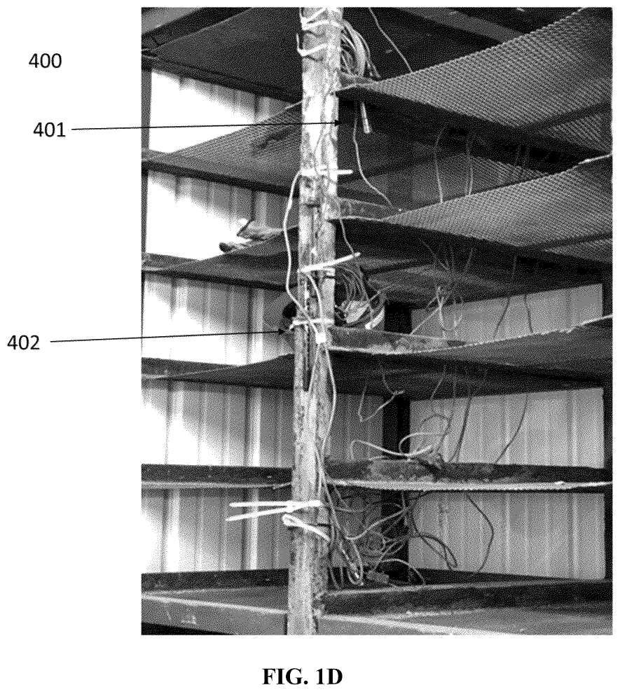

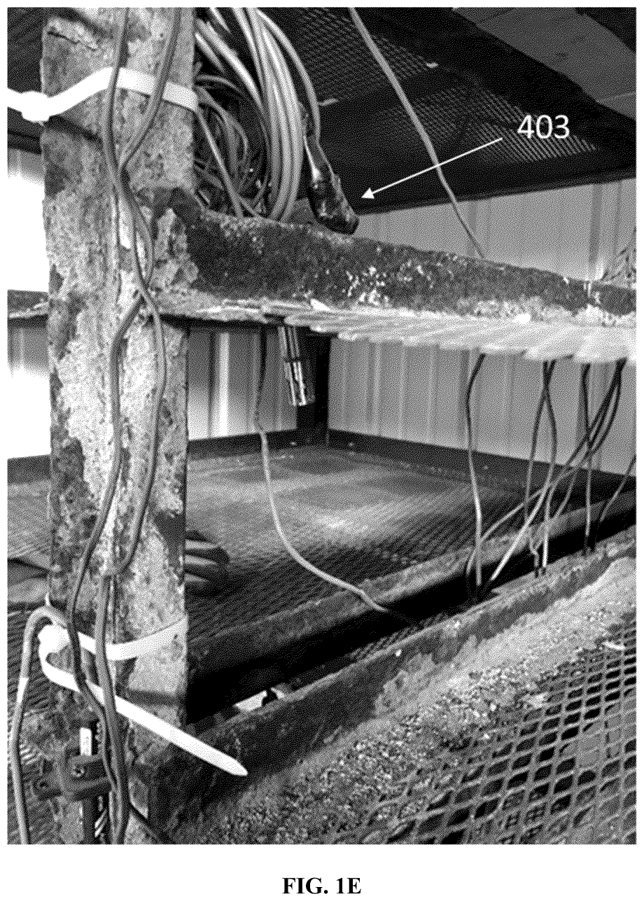

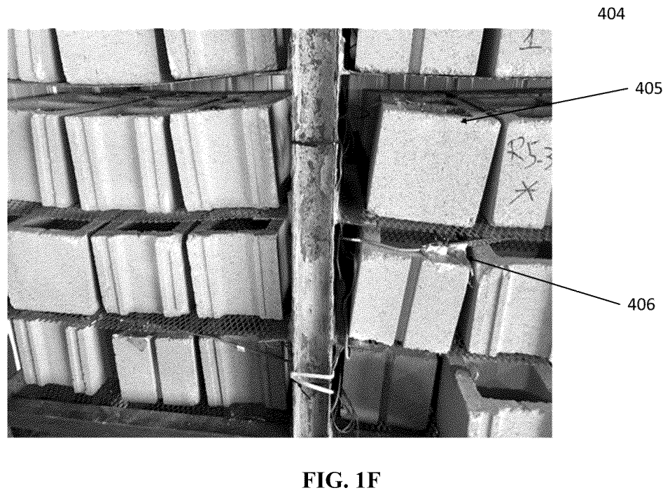

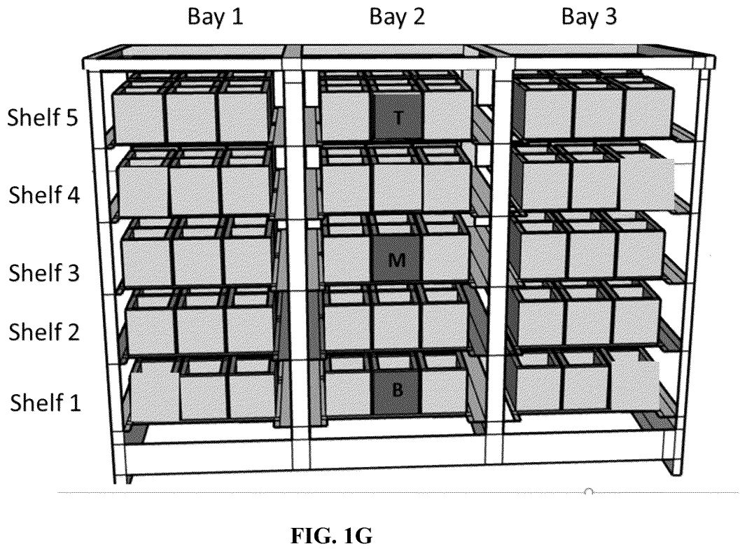

As used herein, “self-sensing instrumentation system” is a system which integrates sensors for acquiring real-time temperature and/or relative humidity of chamber and/or concrete in a chamber. The system may also measure, or is coupled to a system which measures, mass change data (or temperature, humidity, or a combination of measurements) of concrete inside of the curing chamber while a carbonation process is occurring. The system may also measure temperature, relative humidity, CO₂ concentration, and flow rate of gas at inlet and outlet of curing chamber to determine water mass balance. The system may be coupled to a controller, or may be configured to send control signals, which operate to modify the temperature, flow rate, or relative humidity, of the conditioned gas based in part or in whole on the aforementioned real-time acquired data. In certain examples, one programmable logic controller (PLC) would acquire data and also send control signals. In some examples, this means using active or self-adjusting processing conditions by real-time monitoring of temperature and relative humidity of concrete in the concrete chamber. For example, the sensors of the system depicted in FIGS. 1C-1F, which show sensors and instruments connected to a system controller can be used to provide real-time communication. This allows for the active adjustment of gas processing conditions during the curing cycle. This, in turn, reduces the processing energy without sacrificing material performance and CO₂ sequestration efficiency. The self-sensing instrumentation system may also include a logic controller.

As used herein, the data acquisition system logs the data and communicates with the control panel for the active curing process.

As used herein, the term “a carbonated concrete composite” refers to a carbonated concrete object (e.g., a building material) made from early-age (e.g., fresh) concrete that is then contacted with a CO₂-containing curing gas having a suitable CO₂ concentration.

As used herein, “alkaline-rich mineral materials” refers to materials which include Ca and/or Mg and which are used in industrial processes or industrial residues. Alkaline-rich mineral materials include, but are not limited to, Ca(OH)₂, lime kiln dust, lime, hydrated lime, cement kiln dust, calcium-rich coal combustion residues, slag, off-spec fly ashes, biomass ashes, fluidized bed combustion ashes, circulating fluidized bed ashes, off-spec limes, mineral sorbent/scrubbing residues comprising anhydrous CaO and/or Ca(OH)₂, and combinations thereof. The alkaline-rich mineral materials may further comprise at least one of oxides, hydroxides, carbonates, silicates, sulfites, sulfates, chlorides, nitrates, or nitrites of calcium and/or magnesium, or any combination thereof.

As used herein, the term “material performance of a carbonated concrete composite” is defined as porosity, compressibility, and/or other mechanical or strength measurement (e.g., Young's modulus, yield strength, ultimate strength, fracture point, etc.).

As used herein, the term “negatively affecting the material performance” refers to a material performance which is reduced in magnitude by a factor of 10 or more.

As used herein, the term “uniform material performance of a carbonated concrete component” refers to substantially uniform material properties throughout the concrete component. That is, there are no significant gradients or variations in material performance from one area of the concrete composite to another area of the concrete composite.

As used herein, the term “material performance gradient” refers to a gradients in CO₂ content, porosity and/or compressibility (i.e., physical properties of materials) in the carbonated concrete composite. Gradients in CO₂ content and physical properties of materials may result from non-uniform carbonation reaction and/or non-uniform temperature and relative humidity in the curing chamber. In various embodiments, for uniform material performance, the porosity, measured as a volume percent, and/or the compressibility does not vary by more than ±25% over a concrete volume unit of 1 m³. In various embodiments, for uniform material performance, the porosity and/or compressibility does not vary by more than ±20% over a concrete volume unit of 1 m³. In various embodiments, for uniform material performance, the porosity and/or compressibility does not vary by more than ±15% over a concrete volume unit of 1 m³. In various embodiments, for uniform material performance, the porosity and/or compressibility does not vary by more than ±10% over a concrete volume unit of 1 m³. In various embodiments, for uniform material performance, the porosity and/or compressibility does not vary by more than ±10% over a concrete volume unit of 10 cm³. In various embodiments, for uniform material performance, the porosity and/or compressibility does not vary by more than ±5% over a concrete volume unit of 10 cm³. In various embodiments, for uniform material performance, the porosity and/or compressibility does not vary by more than ±1% over a concrete volume unit of 10 cm³. For example, the compressibility may be measured according to ASTM C140 under uniaxial monotonic displacement-controlled loading using a hydraulic jack with a capacity of 800 kN. In this example, the carbonated concrete composite does not have a material performance gradient if the compressibility does not vary by more than ±10%, preferably ±5% over a concrete volume unit of 10 cm³.

As used herein, “carbonated materials” refers to materials made by contacting CO₂ with an alkaline-rich mineral material. Carbonate materials include, but are not limited to, calcium carbonate, calcite, vaterite, aragonite, or any combination thereof. Carbonated materials may include oxides, hydroxides, carbonates, silicates, sulfites, sulfates, chlorides, nitrates, or nitrites of calcium and/or magnesium and/or other uni-/multi-valent elements, or any combination thereof.

Herein, a “residue” is a material which has been used, for example, in concrete production; or in a flue gas treatment, for example, as a sorbent or scrubbing materials that are used for flue gas treatment or byproducts that are generated during industrial processes such as cement and lime manufacturing. A residue may include hydrated lime, lime kiln dust, cement kiln dust, fly ash, limestone, or combinations thereof. A residue may be referred to in the art as a mineral sorbent.

As used herein, the term “green body” refers to a concrete precursor. Green bodies and concrete products are used interchangeably herein, for example when describing a carbonation reaction in which a CO₂-containing gas is in contact with materials in a carbonation chamber. Those materials may be referred to interchangeably as green bodies and concrete products.

As used herein, the term “rate of carbonation” refers to the rate which CO₂ is consumed. To quantify the carbonation kinetics, the time-CO₂ uptake profiles are fitted to an equation of the form

$$C ( t ) = C ( {t}_{u} ) ( 1 - exp [ ( - {k}_{carb} t ) / C ( {t}_{u} ) ] ) \qquad ( Eq . 6 )$$

where k_{carb} is the apparent carbonation rate constant and C(tᵤ) is the ultimate CO₂ uptake at the end of carbonation curing duration.

As used herein, “gas velocity,” refers to the property of a gas that characterizes is flow rate and flow direction.

For example, a carbonation at or above 0.005 per hour means that k_{carb} is a value 0.005 or greater. This would include, but is not limited to, k_{carb} of 0.05, or 0.5, or 1, or 2. Herein, k_{carb} is equal to, or greater than, 0.05, and equal to, or less than, 3. In certain embodiments, k_{carb} may be equal to, or greater than, 0.05, and equal to, or less than, 2. In other embodiments, k_{carb} is about 0.05. In still other embodiments, k_{carb} is 0.1. In some other embodiments, k_{carb} is 0.2. In yet other embodiments, k_{carb} is 0.3. In certain other embodiments, k_{carb} is 0.4. In other embodiments, k_{carb} is 0.5. In some other embodiments, k_{carb} is 0.6. In some embodiments, k_{carb} is 0.7. In some other embodiments, k_{carb} is 0.8. In certain embodiments, k_{carb} is 0.9. In certain other embodiments, k_{carb} is 1.0. In still other embodiments, k_{carb} is 1.1. In some other embodiments, k_{carb} is 1.2. In other embodiments, k_{carb} is 1.3. In yet other embodiments, k_{carb} is 1.4. In some other embodiments, k_{carb} is 1.5. In other embodiments, k_{carb} is 1.6. In certain embodiments, k_{carb} is 1.7. In certain other embodiments, k_{carb} is 1.8. In another embodiments, k_{carb} is 1.9. In yet another embodiments, k_{carb} is 2.0. In still another embodiments, k_{carb} is 2.1. In certain other embodiments, k_{carb} is 2.2. In other embodiments, k_{carb} is 2.3. In some other embodiments, k_{carb} is 2.4. In yet other embodiments, k_{carb} is 2.5. In certain embodiments, k_{carb} is 2.6. In certain other embodiments, k_{carb} is 2.7. In other embodiments, k_{carb} is 2.8. In some other embodiments, k_{carb} is 2.9. In yet other embodiments, k_{carb} is 3.0.

Herein, k_{carb} is equal to, or greater than, about 0.05, and equal to, or less than, 3. In certain embodiments, k_{carb} may be equal to, or greater than, about 0.05, and equal to, or less than, 2. In other embodiments, k_{carb} is about 0.05. In still other embodiments, k_{carb} is about 0.1. In some other embodiments, k_{carb} is about 0.2. In yet other embodiments, k_{carb} is about 0.3. In certain other embodiments, k_{carb} is about 0.4. In other embodiments, k_{carb} is about 0.5. In some other embodiments, k_{carb} is about 0.6. In some embodiments, k_{carb} is about 0.7. In some other embodiments, k_{carb} is about 0.8. In certain embodiments, k_{carb} is about 0.9. In certain other embodiments, k_{carb} is about 1.0. In still other embodiments, k_{carb} is about 1.1. In some other embodiments, k_{carb} is about 1.2. In other embodiments, k_{carb} is about 1.3. In yet other embodiments, k_{carb} is about 1.4. In some other embodiments, k_{carb} is about 1.5. In other embodiments, k_{carb} is about 1.6. In certain embodiments, k_{carb} is about 1.7. In certain other embodiments, k_{carb} is about 1.8. In another embodiments, k_{carb} is about 1.9. In yet another embodiments, k_{carb} is about 2.0. In still another embodiments, k_{carb} is about 2.1. In certain other embodiments, k_{carb} is about 2.2. In other embodiments, k_{carb} is about 2.3. In some other embodiments, k_{carb} is about 2.4. In yet other embodiments, k_{carb} is about 2.5. In certain embodiments, k_{carb} is about 2.6. In certain other embodiments, k_{carb} is about 2.7. In other embodiments, k_{carb} is about 2.8. In some other embodiments, k_{carb} is about 2.9. In yet other embodiments, k_{carb} is about 3.0.

As used herein, “real-time measuring,” refers to measuring occurring during a carbonation curing process.

As used herein, “recycle ratios,” refers to the number of times a CO₂-containing gas is cycled out of a carbonation chamber and back into the chamber after being conditioned. 0 recycle ratio means no recycling of gas. The CO₂-containing gas makes a single pass through the carbonation chamber in a 0 recycle ratio. The number of times a CO₂-containing gas is recycled is the recycled ratio. Recycle ratio is calculated based on flow rate.

As used herein, a gas conditioning apparatus typically includes a chiller, a heater, a condenser, a blower, and humidifier.

### Systems

Provided herein are carbonation curing systems useful for contacting carbon dioxide (CO₂) gas streams with concrete materials under ambient pressure. This contacting causes a carbonation reaction in which CO₂ forms materials, such as, but not limited to, calcium carbonate (CaCO₃). The carbonation reactions set forth herein are useful for strengthening concrete and concrete components. The carbonation curing systems are useful for strengthening concrete and concrete components by hardening the concrete and concrete components via carbonation and hydration reactions which occur in the carbonation curing system.

The curing system comprises an enclosed chamber in which concrete components are placed and contacted with a CO₂-containing gas stream at ambient pressure. The curing system also comprises a gas processing apparatus to deliver and condition gas streams. The system can actively control and continuously adjust the temperature, relative humidity, and flow rate of incoming gas to enhance the carbonation reaction rate, reduce the curing cycle, reduce system energy demand, and minimize gradients of material properties of concrete products after the curing process. In some examples, by reversing the flow (i.e., flow reversal) of the CO₂ gas, it is possible to minimize gradients in temperature, drying, carbonation, and properties of materials. Some of these properties are physical properties such as strength. Active control means that a self-sensing instrumentation system inside of the curing chamber monitors the temperature and relative humidity of the carbonation chamber as well as the temperature and relative humidity of the concrete, or mass change thereto, and actively adjusts in real-time the CO₂-containing gas stream's temperature, relative humidity, flow rate, or CO₂ concentration, or a combination thereof, to maximize the carbonation rate, or to maximize the carbonation rate in an energy efficient manner. Piping interconnects the curing chamber to the gas processing apparatus. The curing system is a flow-through process that comprises gas recirculation as a means to enhance gas velocity and maximize CO₂ sequestration efficiency. The sensible heat from the recirculating gas can be used transfer heat from gas to green bodies/concrete products to increase concrete temperature. The gas processing apparatus comprises heaters and heat exchangers to heat the CO₂-containing gas stream to the desired temperature before entering the curing chamber to transfer heat to concrete products, or precursors thereto, and enhance carbonation reaction without the need for external heating jackets. The gas processing system and curing chamber are instrumented (coupled to sensors) to provide real-time communication to the system controller and thereby actively adjust gas processing conditions during the curing cycle to optimize system processing energy while enhancing material performance.

In one aspect, set forth herein is an active carbonation curing apparatus comprising: a flow-through chamber at ambient pressure; and a gas conditioning apparatus comprising at least one heat exchanger, at least one blower, and at least one chiller; wherein: the gas conditioning apparatus is configured to condition a CO₂-containing gas stream that flows from the gas conditioning apparatus to the flow-through chamber; and wherein: the flow-through chamber comprises at least one sensor to measure the temperature in the carbonation chamber and humidity and gas velocity; the flow-through chamber comprises at least one green body or at least one concrete component with a sensor coupled thereto to measure the green body's, or the concrete component's, temperature and humidity, and/or mass change; the flow-through chamber comprises a self-sensing instrumentation system controller configured to monitor temperature and relative humidity and actively adjust the gas condition apparatus.

In another aspect, set forth herein is an active carbonation curing apparatus comprising: a flow-through chamber at ambient pressure; and a gas conditioning apparatus comprising at least one heat exchanger, at least one blower, and at least one chiller; wherein: the gas conditioning apparatus is configured to condition a CO₂-containing gas stream that flows from the gas conditioning apparatus to the flow-through chamber; and wherein: the flow-through chamber comprises at least one self-sensing instrumentation system, comprising sensors and at least one system controller, to measure the temperature in the carbonation chamber, humidity, CO₂ concentration, and gas velocity; the flow-through chamber comprises at least one self-sensing instrumentation system, comprising sensors and at least one system controller, to measure temperature and humidity and gas flow rate at inlet and outlet of curing chamber; the flow though chamber configured to receive at least one green body and at least one concrete component and have a sensor coupled thereto to measure the green body's, or the concrete component's, temperature and humidity, and mass change; the flow-through chamber comprises at least one gas flow piping system and remote damper control with a sensor coupled thereto to control gas flow direction in the curing chamber; the gas conditioning apparatus is configured to actively adjust one or more CO₂-containing gas properties selected from temperature, relative humidity, and gas flow rate.

Herein, the at least one self-sensing instrumentation system, unless specified otherwise to the contrary, includes a single programmable logic controller (PLC, i.e., one computer) which measures, or is configured to measure, temperature (T), relative humidity (RH), flow rate, CO₂ concentration, or a combination thereof, at an inlet and at an outlet of a curing chamber; and also measures, or is configured to measure, T, RH, mass change, or a combination thereof, in a curing green body also in the curing chamber. The PLC dynamically conditions, or is configured to condition, T, RH, flow rate, or a combination thereof, in a flowing CO₂ stream based on these measurements. One PLC (i.e., one computer) may be configured to receive all measurements and dynamically condition the CO₂ stream before the CO₂ stream enters the curing chamber.

In some examples, including any of the foregoing, the self-sensing instrumentation system can be used with an “open-loop (flow through)” carbonation reactor.

In some examples, including any of the foregoing, the self-sensing instrumentation system can be used with a “closed-loop” type carbonation reactor.

In yet another aspect, set forth herein is an active carbonation curing apparatus comprising: a flow-through chamber at ambient pressure; and a gas conditioning apparatus comprising at least one heat exchanger, at least one blower, and at least one chiller; wherein: the gas conditioning apparatus is configured to condition direct air captured CO₂ that flows from the gas conditioning apparatus to the flow-through chamber; and wherein: the flow-through chamber comprises at least one sensor to measure the temperature in the carbonation chamber and humidity and gas velocity; the flow-through chamber comprises at least one green body or at least one concrete component with a sensor coupled thereto to measure the green body's, or the concrete component's, temperature and humidity, and/or mass change; the flow-through chamber comprises self-sensing instrumentation system controller configured to monitor temperature and relative humidity and actively adjust the gas condition apparatus.

The disclosure further provides an active carbonation curing apparatus comprising: a flow-through chamber at ambient pressure; and a gas conditioning apparatus comprising at least one heat exchanger, at least one blower, and at least one chiller; wherein: the gas conditioning apparatus is configured to condition a CO₂-containing gas stream that flows from the gas conditioning apparatus to the flow-through chamber; and wherein: the flow-through chamber comprises at least one self-sensing instrumentation system, comprising sensors and at least one system controller, to measure the temperature in the carbonation chamber, humidity, CO₂ concentration, and gas velocity; the flow-through chamber comprises at least one self-sensing instrumentation system, comprising sensors and at least one system controller, to measure temperature and humidity and gas flow rate at inlet and outlet of curing chamber; the flow-through chamber comprises at least one green body or at least one concrete component, or both, with a sensor coupled thereto to measure the green body's, or the concrete component's, temperature and humidity, and mass change; the flow-through chamber comprises at least one gas flow piping system and remote damper control with a sensor coupled thereto to control gas flow direction in the curing chamber; the gas conditioning apparatus comprises is configured to actively adjust CO₂-containing gas properties selected from temperature, relative humidity, gas flow rate, and combinations thereof.

In some examples, including any of the foregoing, the at least one self-sensing instrumentation system senses CO₂ concentration.

In some examples, including any of the foregoing, the active carbonation curing apparatus includes at least one gas recirculation line coupled to the flow-through chamber. The heat from the recirculating gas can, in some examples, be used to warm the curing chamber or the green bodies/concrete components.

In some examples, including any of the foregoing, the active carbonation curing apparatus includes a de-humidifier.

In some examples, including any of the foregoing, the active carbonation curing apparatus is configured to flow a CO₂-containing gas stream at varying temperature, relatively humidity, and flow rate through the flow-through chamber to contact the at least one green body or concrete component.

In some examples, including any of the foregoing, the active carbonation curing apparatus is configured to recirculate a CO₂-containing gas stream out of the flow-through chamber and back into the flow-through chamber.

In some examples, including any of the foregoing, the active carbonation curing apparatus is configured for CO₂ flow reversal. The flow reversal can help eliminate dead zones in the chamber or also eliminate gradients within the chamber.

In some examples, including any of the foregoing, the active carbonation curing apparatus includes a recirculation system substantially as shown in FIG. 1A.

In some examples, including any of the foregoing, the system controller is coupled to the at least one sensor to measure the temperature in the carbonation chamber and relative humidity and gas velocity.

In some examples, including any of the foregoing, the system controller is configured to be coupled to the sensor measuring the green body's, or the concrete component's, temperature and relative humidity, and mass change during carbonation curing.

In some examples, including any of the foregoing, the system controller is coupled to the sensor measuring the green body's, or the concrete component's, temperature and humidity and/or mass change during carbonation curing.

In some examples, including any of the foregoing, the system controller is coupled to the gas conditioning apparatus, and wherein system controller is configured to send signals to the at least one heat exchanger, at least one blower, at least one chiller, or a combination thereof, to adjust the temperature, relative humidity, and flow rate of the CO₂-containing flue gas.

In some examples, including any of the foregoing, the temperature of the CO₂-containing gas stream in the flow-through chamber is higher than the temperature of the at least one green body or concrete component.

In some examples, including any of the foregoing, the flow-through chamber does not comprise external heating sources such as heating jackets.

In some examples, including any of the foregoing, the curing chamber comprises gas inlets and gas outlets to create a flow-through configuration so that the flow-through chamber is not pressurized above ambient pressure.

In some examples, including any of the foregoing, the curing chamber comprises remote balancing damper to change gas flow direction frequently during carbonation curing and create flow reversal so as to minimize gradients in temperature and relative humidity and improve uniformity of material properties. In some examples, frequently may be every 15 mins. In some examples, frequently may be every 30 mins. In some examples, frequently may be every 45 mins. In some examples, frequently may be every 60 mins. In some examples, frequently may be every 15 mins to 5 hours or any other ranges or value in between 15 mins to 5 hours.

In some examples, including any of the foregoing, the CO₂-containing gas comprises CO₂ concentration at or above 5% by volume.

In some examples, including any of the foregoing, the CO₂-containing gas comprises CO₂ concentration at or above 5% by volume.

In some examples, including any of the foregoing, the flow-through chamber is not pressurized above atmospheric pressure.

In some examples, including any of the foregoing, the flow-through chamber comprises at least one curing chamber.

In some examples, including any of the foregoing, the gas processing apparatus comprises a condensing heat exchanger.

In some examples, including any of the foregoing, the gas processing apparatus comprises an air-cooled condenser.

In some examples, including any of the foregoing, the condensing heat exchanger is gas-gas, water-gas, or a combination thereof.

In some examples, including any of the foregoing, the gas processing apparatus comprises a heat recovery exchanger.

In some examples, including any of the foregoing, the heat recovery exchanger is gas-gas, water-gas, or a combination thereof.

In some examples, including any of the foregoing, the gas processing apparatus comprises a chiller coupled to the condensing heat exchanger.

In some examples, including any of the foregoing, the chiller is air-cooled or water-cooled.

In some examples, including any of the foregoing, the gas processing apparatus further comprising a humidity control system.

In some examples, including any of the foregoing, the CO₂-containing gas has a relative humidity from about 10% to about 90%.

In some examples, including any of the foregoing, the CO₂-containing gas has a temperature from about 20° C. to about 80° C.

In some examples, including any of the foregoing, the flow-through chamber is made of concrete.

In some examples, including any of the foregoing, the flow-through chamber is made of a flexible material.

In some examples, including any of the foregoing, the flow-through chamber is a tent.

In some examples, including any of the foregoing, the flow-through chamber is a polymer-based enclosure.

In some examples, including any of the foregoing, the pipes through which the CO₂-containing gas flows, and wherein the pipes are flexible.

In some examples, including any of the foregoing, the flow-through chamber is a batch reactor.

In some examples, including any of the foregoing, the flow-through chamber is a plug flow reactor.

In some examples, including any of the foregoing, the at least one green body comprises at least one member selected from the group consisting of hydrated lime, portland cement, coal combustion residues, recycled concrete aggregates, natural pozzolans, other industrial solid wastes, or a combination thereof.

In some examples, including any of the foregoing, the green bodies further comprise coal slag, lime kiln dust, cement kiln dust, other industrial alkaline solid wastes, or a combination thereof.

In some examples, including any of the foregoing, the concrete components have a compressive strength from about 5 MPa to about 100 MPa.

### Processes

The methods include, but are not limited to, contacting a conditioned flue gas containing CO₂ inside of a carbonation chamber with green bodies or concrete components in which flue gas properties such as temperature, relative humidity, flow rate, and gas flow direction are self-adjusted during a curing process based on self-sensing instrumentation system inside of curing chamber and inlet and outlet points of curing chamber to improve CO₂ capture efficiency and concrete performance while reducing system processing energy. The flow-through (i.e., open loop) nature of this curing system also allows for moderated heat transfer from a CO₂-containing gas to concrete during carbonation curing. This heat transfer is useful for adjusting the moisture content of concrete that results. This also results in a shorter carbonation curing cycle and a lower process energy while enhancing material performance, or meeting industry standards, through progressing carbonation-hydration reactions.

The methods include, but are not limited to, contacting a conditioned gas containing CO₂ inside of a carbonation chamber with green bodies or concrete components in which flue gas properties such as temperature, relative humidity, flow rate, and gas flow direction are self-adjusted during a curing process based on self-sensing instrumentation system inside of curing chamber and inlet and outlet points of curing chamber to improve CO₂ capture efficiency and concrete performance while reducing system processing energy. The flow-through (i.e., open loop) nature of this curing system also allows for sensible heat transfer from a CO₂-containing gas to concrete during carbonation curing. This heat transfer is useful for adjusting the moisture content of concrete that results. This also results in a shorter carbonation curing cycle and a lower process energy while enhancing material performance, or meeting industry standards, through progressing carbonation-hydration reactions.

In some examples, including any of the foregoing, the gas conditioning apparatus actively adjusts the temperature, relative humidity, flow rate, CO₂ concentration, or a combination thereof, in the CO₂-containing gas stream to provide a conditioned gas as a function of the temperature or relative humidity of the at least one green body or concrete component.

In some examples, including any of the foregoing, the gas conditioning apparatus actively adjusts the temperature, relative humidity, flow rate, CO₂ concentration, or a combination thereof, in the CO₂-containing gas stream to provide a conditioned gas to increase the rate of carbonation in the at least one green body or concrete component.

In some examples, including any of the foregoing, the flow-through chamber comprises at least one green body or at least one concrete component with a sensor coupled thereto to measure the green body's, or the concrete component's, temperature and humidity.

In some examples, including any of the foregoing, the flow-through chamber comprises a system controller configured to monitor temperature and relative humidity and actively adjust the gas condition apparatus.

In some examples, including any of the foregoing, the conditioned gas has a different temperature, relative humidity, flow rate, CO₂ concentration, or a combination thereof, than the CO₂-containing gas before it is conditioned.

In some examples, including any of the foregoing, the CO₂-containing gas flows from the gas conditioning apparatus to the flow-through chamber after it is conditioned.

In some examples, including any of the foregoing, the conditioned CO₂ gas stream has a temperature, relative humidity, CO₂ amount, gas stream flow rate, or a combination thereof to provide a carbonation rate constant of the one green body or concrete component that is at or above 0.005.

In some examples, including any of the foregoing, the process includes recirculating the conditioned CO₂ gas stream from the flow-through chamber back into the flow-through chamber.

In some examples, including any of the foregoing, the process includes removing water from concrete materials inside the flow-through chamber to adjust moisture content.

In some examples, including any of the foregoing, the process includes continuously flowing the conditioned gas through the flow-through chamber.

In some examples, including any of the foregoing, using the gas conditioning apparatus to actively adjust the temperature, relative humidity, flow rate, CO₂ concentration, or a combination thereof, in the CO₂-containing gas stream to provide a conditioned gas comprises flowing a CO₂ gas stream through a heat exchanger, a heater, a blower, a chiller, air cooler, or a combination thereof in the gas processing apparatus.

In some examples, including any of the foregoing, using the gas conditioning apparatus to actively adjust the temperature, relative humidity, flow rate, or a combination thereof, in the CO₂-containing gas stream through self-sensing instrumentation system inside of the curing chamber to provide a conditioned gas that increases the rate of carbonation in the at least one green body or concrete component.

In some examples, including any of the foregoing, using the gas conditioning apparatus to actively adjust the temperature, relative humidity, flow rate, CO₂ concentration, or a combination thereof, in the CO₂-containing gas stream to provide a conditioned gas reduces total energy consumption without negatively affecting the material performance of the product produced by the process.

In some examples, including any of the foregoing, process includes acquiring real-time temperature, humidity, flow rate, or a combination thereof, data and actively conditioning a CO₂ gas stream in the gas conditioning apparatus to provide a conditioned gas based on the acquired real-time temperature, humidity, flow rate, or a combination thereof data.

In some examples, including any of the foregoing, the at least one green body or concrete component has a temperature at or above 30° C.

In some examples, including any of the foregoing, the at least one green body or concrete component has an internal relative humidity drops lower than 95%.

In some examples, including any of the foregoing, the process includes flowing conditioned CO₂ gas stream in the flow-through chamber which has a relative humidity between 10%-50% until internal temperature of the at least one green body or concrete component reaches above 30° C.

In some examples, including any of the foregoing, the process includes flowing conditioned gas in the flow-through chamber with temperature between 20° C.-80° C.

In some examples, including any of the foregoing, the process includes flowing conditioned gas in the flow-through chamber with temperature between 20° C.-60° C.

In some examples, including any of the foregoing, the process includes flowing conditioned gas in the flow-through chamber with relative humidity of 10%-90%.

In some examples, including any of the foregoing, the process includes flowing conditioned gas in the flow-through chamber with relative humidity of 50%-90%.

In some examples, including any of the foregoing, the process the rate of carbonation (e.g., the rate of carbonation in the at least one green body or at least one concrete component in the carbonation chamber) is at or above 0.005 per hour.

In some examples, including any of the foregoing, the process includes passing the CO₂ gas stream through a condensing heat exchanger to form a condensate.

In some examples, including any of the foregoing, the process includes passing the CO₂ gas stream through a recovery heat exchanger to recover waste heat.

In some examples, including any of the foregoing, the process includes using the waste heat to heat a CO₂ gas stream to about 30° C. to about 80° C. before the CO₂ gas stream enters the flow-through chamber.

In some examples, including any of the foregoing, the process includes atomizing water into a CO₂ gas stream to humidify gas before the CO₂ gas stream enters the flow-through chamber.

In some examples, including any of the foregoing, the process includes flowing conditioned gas in the flow-through chamber for 8 to 24 hours.

In some examples, including any of the foregoing, the process includes air curing for 0 to 12 hours before flowing conditioned CO₂ gas stream in the flow-through chamber.

In some examples, including any of the foregoing, the process a hydration reaction in the at least one green body or concrete component is activated to about 5% to about 50% by weight. The hydration reaction is measured by determining the amount of non-evaporative water content. One can use thermogravimetric analysis to measure non-evaporative water content, which is one measure of hydration extent.

In some examples, including any of the foregoing, the process includes air curing and adjusting the water vapor in the flow-through chamber such that the relative humidity of air in the flow-through reactor is from about 10% to about 90%.

In some examples, including any of the foregoing, the process includes air curing and adjusting the water vapor in the flow-through chamber such that the relative humidity of air in the flow-through reactor is from about 10% to about 90% before flowing the conditioned gas in the flow-through chamber.

In some examples, including any of the foregoing, the green bodies further comprise coal slag, lime kiln dust, cement kiln dust, other industrial alkaline solid wastes, or a combination thereof.

In some examples, including any of the foregoing, the process includes flowing conditioned gas in the flow-through chamber at a flow rate at least 1 standard liter per minute (slpm). The maximum flow rate is based in part on the carbonation curing reactor and the concrete type.

In some examples, including any of the foregoing, the CO₂-containing gas stream is effluent from an industrial source, a commercially-available CO₂ source, liquefied CO₂, biomass-derived CO₂ or atmospherically-derived CO₂.

### Additional Embodiments

Embodiment one: An active carbonation curing apparatus comprising: a flow-through chamber at ambient pressure; and a gas conditioning apparatus comprising at least one heat exchanger, at least one blower, and at least one chiller; wherein: the gas conditioning apparatus is configured to condition a CO₂-containing gas stream that flows from the gas conditioning apparatus to the flow-through chamber; and wherein: the flow-through chamber comprises at least one self-sensing instrumentation system comprising sensors to measure, at an inlet and an outlet of the curing chamber, the temperature in the carbonation chamber, humidity, CO₂ concentration, and gas velocity; and wherein the at least one self-sensing instrumentation system is configured to send control signals to the gas conditioning apparatus; the flow-through chamber is configured to receive at least one green body or at least one concrete component, or both, with a sensor coupled thereto to measure the green body's, or the concrete component's, temperature, humidity, mass change, or a combination thereof; the flow-through chamber comprises at least one gas flow piping system and remote damper control to control gas flow direction in the curing chamber; the gas conditioning apparatus is configured to actively adjust one or more CO₂-containing gas properties selected from temperature, relative humidity, gas flow rate, and combinations thereof.

Embodiment two: The active carbonation curing apparatus of embodiment 1, wherein the flow-through chamber comprises at least one green body or at least one concrete component, or both, with a sensor coupled thereto to measure the green body's, or the concrete component's, temperature, humidity, mass change, or combination thereof.

Embodiment three: The active carbonation curing apparatus of embodiment 1 or 2, further comprising at least one gas recirculation line coupled to the flow-through chamber.

Embodiment four: The active carbonation curing apparatus of any one of embodiments 1-3, further comprising a de-humidifier.

Embodiment five: The active carbonation curing apparatus of any one of embodiments 1-4, configured to continuously flow a CO₂-containing gas stream through the flow-through chamber to contact the at least one green body or concrete component and transfer gas sensible heat to concrete.

Embodiment six: The active carbonation curing apparatus of any one of embodiments 1-5, configured to recirculate a CO₂-containing gas stream out of the flow-through chamber and back into the flow-through chamber.

Embodiment seven: The active carbonation curing apparatus of any one of embodiments 1-6, wherein the at least one self-sensing instrumentation system is configured to measure the temperature in the carbonation chamber, relative humidity, and gas velocity inside of the curing chamber.

Embodiment eight: The active carbonation curing apparatus of any one of embodiments 1-7, wherein the at least one self-sensing instrumentation system is configured to measure temperature, relative humidity, and gas flow rate at the inlet and the outlet of the curing chamber.

Embodiment nine: The active carbonation curing apparatus of any one of embodiments 1-8, wherein the at least one self-sensing instrumentation system is configured to measure the green body's, or the concrete component's, temperature, relative humidity, mass change during carbonation curing, or a combination thereof.

Embodiment ten: The active carbonation curing apparatus of any one of embodiments 1-9, wherein the self-sensing instrumentation system is coupled to the gas conditioning apparatus, and wherein the self-sensing instrumentation system is configured to send control signals to the at least one heat exchanger, at least one blower, at least one chiller, at least one air-cooler or a combination thereof, to adjust the temperature, relative humidity, and/or flow rate of the CO₂-containing flue gas.

Embodiment eleven: The active carbonation curing apparatus of any one of embodiments 1-10, wherein the temperature of the CO₂-containing gas stream in the flow-through chamber is higher than the temperature of the at least one green body or concrete component.

Embodiment twelve: The active carbonation curing apparatus of any one of embodiments 1-11, wherein the flow-through chamber does not comprise an external heating jacket.

Embodiment thirteen: The active carbonation curing apparatus of any one of embodiments 1-12, wherein the curing chamber comprises gas inlets and gas outlets to create a flow-through configuration so that the flow-through chamber is not pressurized above ambient pressure.

Embodiment fourteen: The active carbonation curing apparatus of any one of embodiments 1-13, wherein the curing chamber comprises a remote balancing damper to change gas flow direction frequently during carbonation curing and create flow reversal.

Embodiment fifteen: The active carbonation curing apparatus of any one of embodiments 1-14, wherein the CO₂-containing gas comprises CO₂ concentration at or above 5% by volume.

Embodiment sixteen: The active carbonation curing apparatus of any one of embodiments 1-15, wherein the flow-through chamber comprises at least one curing chamber

Embodiment seventeen: The active carbonation curing apparatus of any one of embodiments 1-16, wherein the gas processing apparatus comprises a condensing heat exchanger.

Embodiment eighteen: The active carbonation curing apparatus of embodiment 17, wherein the condensing heat exchanger is gas-gas, water-gas, or a combination thereof.

Embodiment nineteen: The active carbonation curing apparatus of any one of embodiments 1-18, wherein the gas processing apparatus comprises a heat recovery exchanger.

Embodiment twenty: The active carbonation curing apparatus of embodiment 19, wherein the heat recovery exchanger is gas-gas, water-gas, or a combination thereof.

Embodiment twenty-one: The active carbonation curing apparatus of any one of embodiments 17-20, wherein the gas processing apparatus comprises a chiller coupled to the condensing heat exchanger.

Embodiment twenty-two: The active carbonation curing apparatus of embodiment 21, wherein the chiller is air-cooled or water-cooled.

Embodiment twenty-three: The active carbonation curing apparatus of any one of embodiments 1-22, wherein the gas processing apparatus further comprises a humidity control system.

Embodiment twenty-four: The active carbonation curing apparatus of any one of embodiments 1-23, wherein the CO₂-containing gas has a relative humidity from about 10% to about 90%.

Embodiment twenty-five: The active carbonation curing apparatus of any one of embodiments 1-23, wherein the CO₂-containing gas has a temperature from about 20° C. to about 80° C.

Embodiment twenty-six: The active carbonation curing apparatus of any one of embodiments 1-25, wherein the flow-through chamber is made of concrete.

Embodiment twenty-seven: The active carbonation curing apparatus of any one of embodiments 1-25, wherein the flow-through chamber is made of a flexible material.

Embodiment twenty-eight: The active carbonation curing apparatus of any one of embodiments 1-25, wherein the flow-through chamber is a tent.

Embodiment twenty-nine: The active carbonation curing apparatus of any one of embodiments 1-25, wherein the flow-through chamber is a polymer-based enclosure.

Embodiment thirty: The active carbonation curing apparatus of any one of embodiments 1-29, further comprising pipes through which the CO₂-containing gas flows, and wherein the pipes are flexible.

Embodiment thirty-one: The active carbonation curing apparatus of any one of embodiments 1-30, wherein the flow-through chamber is a batch reactor.

Embodiment thirty-two: The active carbonation curing apparatus of any one of embodiments 1-31, wherein the flow-through chamber is a plug flow reactor.

Embodiment thirty-three: The active carbonation curing apparatus of any one of embodiments 1-32, wherein the at least one green body comprises at least one member selected from the group consisting of hydrated lime, portland cement, coal combustion residues, recycled concrete aggregates, natural pozzolans, other industrial solid wastes, or a combination thereof.

Embodiment thirty-four: The active carbonation curing apparatus of embodiment 33, wherein the green bodies further comprise coal slag, lime kiln dust, cement kiln dust, other industrial alkaline solid wastes, or a combination thereof.

Embodiment thirty-five: The active carbonation curing apparatus of any one of embodiments 1-34, wherein the concrete components have a compressive strength from about 5 MPa to about 100 MPa after curing.

Embodiment thirty-six: A carbonation process, comprising: providing an active carbonation curing apparatus comprising: a flow-through chamber at ambient pressure and comprising at least one green body or at least one concrete component, or both; and a gas conditioning apparatus coupled to the flow-through chamber and configured to actively condition a CO₂-containing gas stream; measuring the temperature in the carbonation chamber, humidity, CO₂ concentration, and gas velocity in the flow-through chamber; measuring temperature, humidity, mass change, or a combination thereof in the at least one green body or at least one concrete component, or both; using the gas conditioning apparatus to actively adjust the temperature, relative humidity, flow rate, CO₂ concentration, or a combination thereof, in the CO₂-containing gas stream to provide a conditioned gas; and contacting the conditioned gas with the at least one green body or at least one concrete component, or both, in the flow-through chamber.

Embodiment thirty-seven: The process of embodiment 36, wherein the conditioned gas has a different temperature, relative humidity, flow rate, CO₂ concentration, or a combination thereof, than the CO₂-containing gas before it is conditioned.

Embodiment thirty-eight: The process of embodiment 36 or 37, wherein the conditioned CO₂ gas stream has a temperature, relative humidity, CO₂ amount, gas stream flow rate, or a combination thereof to provide a carbonation rate constant of the one green body or concrete component that is at or above 0.005.

Embodiment thirty-nine: The process of any one of embodiments 36-38, further comprising removing evaporated water from concrete inside the flow-through chamber.

Embodiment forty: The process of any one of embodiments 36-39, wherein using the gas conditioning apparatus to actively adjust the temperature, relative humidity, flow rate, CO₂ concentration, or a combination thereof, in the CO₂-containing gas stream to provide a conditioned gas increases the rate of carbonation in the at least one green body or concrete component.

Embodiment forty-one: The process of any one of embodiments 36-40, wherein using the gas conditioning apparatus to actively adjust the temperature, relative humidity, flow rate, CO₂ concentration, or a combination thereof, in the CO₂-containing gas stream to provide a conditioned gas reduces total energy consumption and curing time without negatively affecting the material performance of the product produced by the process of any one of embodiments 36-38.

Embodiment forty-two: The process of any one of embodiments 36-41, further comprising acquiring real-time temperature, humidity, flow rate, or a combination thereof, data and actively conditioning a CO₂ gas stream in the gas conditioning apparatus to provide a conditioned gas based on the acquired real-time temperature, relative humidity, flow rate, or a combination thereof data.

Embodiment forty-three: The process of any one of embodiments 36-42, further comprising initiating the process with conditioned dry and hot CO₂ gas stream to adjust the moisture content of the concrete until a desired relative humidity of the concrete is achieved using a self-sensing instrumentation system in the chamber; curing the at least one green body or at least one concrete component; and flowing cooler and/or more humid CO₂ gas stream to re-introduce water into the concrete to continue carbonation and hydration reactions while reducing system energy demand.

Embodiment forty-four: The process of any one of embodiments 36-43, wherein the at least one green body or concrete component has a temperature at or above 30° C.

Embodiment forty-five: The process of any one of embodiments 36-44, wherein the at least one green body or concrete component has an internal relative humidity drop lower than 95%.

Embodiment forty-six: The process of any one of embodiments 36-45, further comprising flowing conditioned CO₂ gas stream in the flow-through chamber which has a relative humidity between 10%-50% until internal temperature of the at least one green body or concrete component reaches above 30° C.

Embodiment forty-seven: The process of any one of embodiments 36-46, further comprising flowing conditioned gas in the flow-through chamber with temperature between 20° C.-80° C.

Embodiment forty-eight: The process of any one of embodiments 36-47, further comprising flowing conditioned gas in the flow-through chamber with temperature between 20° C.-60° C.

Embodiment forty-nine: The process of any one of embodiments 36-48, further comprising flowing conditioned gas in the flow-through chamber with relative humidity of 10%-90%.

Embodiment fifty: The process of any one of embodiments 36-49, further comprising flowing conditioned gas in the flow-through chamber with relative humidity of 50%-90%.

Embodiment fifty-two: The process of any one of embodiments 36-50, further comprising passing the CO₂ gas stream through a condensing heat exchanger to form a condensate.

Embodiment fifty-three: The process of any one of embodiments 36-51, further comprising passing the CO₂ gas stream through a recovery heat exchanger to recover waste heat.

Embodiment fifty-three: The process of any one of embodiments 36-52, further comprising using the waste heat to heat a CO₂ gas stream to about 20° C. to about 80° C. before the CO₂ gas stream enters the flow-through chamber.

Embodiment fifty-four: The process of any one of embodiments 36-53, further comprising atomizing water into a CO₂ gas stream before the CO₂ gas stream enters the flow-through chamber to control relative humidity within a range of 50%-90%.

Embodiment fifty-five: The process of any one of embodiments 36-54, further comprising flowing conditioned gas in the flow-through chamber for 8 to 24 hours.

Embodiment fifty-six: The process of any one of embodiments 36-55, further comprising air curing for 0 to 12 hours before flowing conditioned CO₂ gas stream in the flow-through chamber.

Embodiment fifty-seven: The process of any one of embodiments 36-56, further comprising flowing conditioned gas in the flow-through chamber at a flow rate of at least 1 standard liters per minute (slpm).

Embodiment fifty-eight: The process of any one of embodiments 36-57, wherein the CO₂-containing gas stream is effluent from an industrial source, a commercially-available CO₂ source, liquefied CO₂, CO₂-containing flue gas stream, biomass-derived CO₂ or atmospherically-derived CO₂.

Embodiment fifty-nine: In another embodiment, set forth herein is a process comprising: flowing a CO₂-containing gas from a gas conditioning apparatus into a carbonation chamber comprising at least one green body; measuring, in real-time, temperature, relative humidity, CO₂ concentration, gas flow rate, gas flow direction, or a combination thereof, in the carbonation chamber to provide a measurement; inputting the measurement into a regression model to determine the extent of carbonation of the at least one green body; sending a control signal to the gas conditioning apparatus while flowing the CO₂-containing gas to: actively condition the CO₂-containing gas based on the extent of carbonation; and effect a multi-step carbonation process. In certain embodiments, the process includes measuring, in real-time, temperature in the carbonation chamber to provide a measurement. In certain embodiments, the process includes measuring, in real-time, relative humidity in the carbonation chamber to provide a measurement. In certain embodiments, the process includes measuring, in real-time, relative temperature and humidity in the carbonation chamber to provide a measurement. In certain embodiments, the process includes measuring, in real-time CO₂ concentration in the carbonation chamber to provide a measurement. In certain embodiments, the process includes measuring, in real-time gas flow rate in the carbonation chamber to provide a measurement. In certain embodiments, the process includes measuring, in real-time, gas flow direction in the carbonation chamber to provide a measurement. In certain embodiments, the process includes measuring, in real-time gas flow rate and flow direction in the carbonation chamber to provide a measurement.

A step herein refers to a process condition in which the temperature, relative humidity, CO₂ concentration, flow rate, and flow direction is constant. A new step means that the temperature, relative humidity, CO₂ concentration, flow rate, and flow direction has been adjusted relative to the previous reaction condition. For example, a carbonation reaction may run for 24 hours at 80° C., 5% CO₂ concentration, 80% RH, and with a flow rate in one direction of 1 standard cubic feet per minute (scfm). Then, in a second step, the carbonation reaction may run for 12 hours at 100° C., 5% CO₂ concentration, 80% RH, and with a flow rate in one direction of 1 scfm. In another example, the carbonation reaction may include a periodic change. For example, the carbonation reaction may include a periodic adjustment whereby the reaction runs at temperature A for 10 minutes and then to temperature B for 10 minutes and then back to temperature A for another 10 minutes. This last example, would include three steps as outlined herein.

In the processes herein, effecting a multi-step carbonation process means that the carbonation process has steps that are distinguished in time based on the temperature, relative humidity, CO₂ concentration, gas flow rate, gas flow direction, or a combination thereof, in the carbonation chamber. For example, a carbonation process that first runs at relative humidity of 10% in a first step for 18 hours. Then in a second step, the process runs at a higher relative humidity of 30% for 6 hours. This would be an example of a multi-step carbonation process.

In some embodiments, including any of the foregoing, the curing chamber comprises a remote balancing damper to change gas flow direction frequently during carbonation curing and create flow reversal.

Embodiment sixty: The process of embodiment 59, wherein measuring further comprises measuring, in real-time, temperature, relative humidity, CO₂ concentration, gas flow rate, gas flow direction, or a combination thereof, in the at least one green body in the carbonation chamber. In certain embodiments, the process includes measuring, in real-time, temperature in the at least one green body in the carbonation chamber. In certain embodiments, the process includes measuring, in real-time, humidity or moisture in the at least one green body in the carbonation chamber. In certain embodiments, the process includes measuring, in real-time, temperature and moisture in the at least one green body in the carbonation chamber.

Embodiment sixty-one: The process of embodiment 59 or 60, further comprising sending a control signal to the gas conditioning apparatus while flowing the CO₂-containing gas to reduce process energy. In certain embodiments, the process comprises optimizing process energy. By adjusting process conditions during the carbonation process, e.g., decrease recycle ratio or decrease flow rate, process energy may be optimized. This means that the energy needed to run the process is minimized. For example, by adjusting the chiller or relative humidity set point, the process energy may be minimized and the process energy optimized. For example, if the relative humidity increases, then the chiller has a lower workload. Also, for example, by decreasing the temperature of the CO₂-containing gas, the heater in the gas conditioning apparatus has a lower workload. In certain embodiments, including any of the foregoing, the process includes increasing the relative humidity of the CO₂-containing gas to reduce process energy. In certain embodiments, including any of the foregoing, the process includes decreasing the temperature of the CO₂-containing gas to reduce process energy. In certain embodiments, including any of the foregoing, the process includes decreasing the flow rate of the CO₂-containing gas to reduce process energy. In certain embodiments, including any of the foregoing, the process includes increasing the relative humidity of the CO₂-containing gas to optimize the process energy. In certain embodiments, including any of the foregoing, the process includes decreasing the temperature of the CO₂-containing gas to optimize the process energy. In certain embodiments, including any of the foregoing, the process includes decreasing the flow rate of the CO₂-containing gas to optimize the process energy.

Embodiment sixty-two: The process of any one of embodiments 59-60, comprising sending a control signal to the gas conditioning apparatus while flowing the CO₂-containing gas to minimize the energy usage.

Embodiment sixty-three: The process of embodiments 61 or 62, comprising optimizing the process energy by at least 5% compared to before optimizing.

Embodiment sixty-four: The process of any one of embodiments 59-63, comprising sending a control signal to the gas conditioning apparatus while flowing the CO₂-containing gas to maintain a carbonation rate above 0.005 L/sec.

Embodiment sixty-five: The process of any one of embodiments 59-64, comprising actively conditioning the CO₂-containing gas so that the carbonation rate in the at least one green body is increased by at least 5% compared to before conditioning.

Embodiment sixty-six: The process of any one of embodiments 59-65, wherein actively conditioning the CO₂-containing gas comprises altering the temperature, relative humidity, CO₂ concentration, gas flow rate, gas flow direction, or a combination thereof, using at least two more steps. For example, in a first step, the CO₂-containing gas may have a temperature of 20° C. and a relative humidity of 50%. Then in a second, subsequent step, the CO₂-containing gas is conditioned so that it has a temperature of 30° C. and a relative humidity of 60%. Then in a third, subsequent step, the CO₂-containing gas is conditioned so that it has a temperature of 30° C. and a relative humidity of 10%. This would be an example of one three step process embodiment.

Embodiment sixty-seven: The process of any one of embodiments 59-66, wherein the regression model is based on previously acquired experimental data that correlated CO₂ uptake, carbonation reaction rate, or a combination thereof, with temperature, relative humidity, CO₂ concentration, gas flow rate, gas flow direction, or a combination thereof.

Embodiment sixty-eight: The process of any one of embodiments 59-67, comprising actively adjusting the temperature, relative humidity, CO₂ concentration, gas flow rate, gas direction, or combinations thereof, in the carbonation chamber.

Embodiment sixty-nine: The process of any one of embodiments 59-68, comprising actively adjusting flow direction in the carbonation chamber. In certain embodiments, this includes changing flow direction from a horizontal flow to a vertical flow. In certain embodiments, this includes changing flow direction from an ordered flow to a turbulent flow.

Embodiment seventy: The process of any one of embodiments 59-69, comprising actively adjusting flow direction in the carbonation chamber over the course of two or more steps.

Embodiment seventy-one: The process of any one of embodiments 59-70, further comprising changing the flow direction inside the carbonation chamber.

Embodiment seventy-two: The process of any one of embodiments 59-71, comprising actively adjusting flow rate in the carbonation chamber.

Embodiment seventy-three: The process of any one of embodiments 59-72, comprising actively reversing flow direction in the carbonation chamber.

Embodiment seventy-four: The process of any one of embodiments 59-73, comprising actively switching flow direction in the carbonation chamber.

Embodiment seventy-five: The process of any one of embodiments 69-74, wherein the actively adjusting is based on real-time data selected from temperature, humidity, CO₂ concentration, flow rate, flow direction, or a combination thereof, in the carbonation chamber.

Embodiment seventy-six: The process of any one of embodiments 59-75, wherein the adjusting actively is based on real-time data selected from temperature, relative humidity, moisture content or a combination thereof, in at least one green body.

Embodiment seventy-seven: The process of any one of embodiments 59-76, further comprising removing water from inside the flow-through chamber.

Embodiment seventy-eight: The process of any one of embodiments 59-77, further comprising initiating the process with conditioned dry and hot CO₂ gas stream to adjust the moisture content of the concrete until a desired relative humidity of the concrete is achieved in the chamber. In some embodiments, the relative humidity is 10%. In some other embodiments, the relative humidity is 20%. In other embodiments, the relative humidity is 30%. In some other embodiments, the relative humidity is 40%. In certain embodiments, the relative humidity is 50%. In some other embodiments, the relative humidity is 60%. In some embodiments, the relative humidity is 70%. In certain other embodiments, the relative humidity is 80%.

Embodiment seventy-nine: The process of any one of embodiments 59-78, further comprising initiating the process with conditioned dry and hot CO₂ gas stream to adjust the moisture content of the concrete until a desired relative humidity of the concrete is achieved in the chamber; curing the at least one green body or at least one concrete component; and flowing cooler and/or more humid CO₂ gas stream to re-introduce water into the concrete to continue carbonation and hydration reactions while reducing system energy demand.

Embodiment eighty: The process of any one of embodiments 59-77, further comprising air curing for 0 to 12 hours before flowing conditioned CO₂ gas stream in the flow-through chamber.

Embodiment eighty-one: The process of any one of embodiments 59-80, wherein the at least one green body has a temperature at or above 30° C., a relative humidity lower than 95%, or both.

Embodiment eighty-two: The process of any one of embodiments 59-81, further comprising flowing conditioned CO₂ gas stream in the flow-through chamber which has a relative humidity greater than 20%.

Embodiment eighty-three: The process of any one of embodiments 59-82, further comprising flowing conditioned CO₂ gas stream in the flow-through chamber which has a relative humidity between 10%-50%.

Embodiment eighty-four: The process of any one of embodiments 59-83, further comprising flowing conditioned CO₂ gas stream in the flow-through chamber which has a relative humidity between 10%-50% until the internal temperature of the at least one green body reaches above 30° C.

Embodiment eighty-five: The process of any one of embodiments 59-84, further comprising flowing conditioned gas in the flow-through chamber with temperature between 20° C.-80° C., relative humidity of 10%-90%, or both.

Embodiment eighty-six: The process of any one of embodiments 59-85, further comprising flowing conditioned gas in the flow-through chamber so the flow-through chamber has less than a 10° C. difference across the length, width, height, or combination thereof, of the chamber.

Embodiment eighty-seven: The process of any one of embodiments 59-86, further comprising using waste heat to heat the CO₂-containing gas to about 20° C. to about 80° C. before the CO₂-containing gas enters the flow-through chamber.

Embodiment eighty-eight: The process of any one of embodiments 59-87, further comprising recirculating the conditioned gas out of the flow-through chamber and back into the flow-through chamber.

Embodiment eighty-nine: The process of any one of embodiments 59-88, further recirculating the conditioned gas out of the flow-through chamber and back into the flow-through chamber at a recycle ratio of 2 or greater.

A carbonated green body made by the process of any one of embodiments 59-89. In some other embodiments, a green body is completely carbonated by the process of any one of embodiments 59-89 and results in a carbonated concrete composite.

In some embodiments, including any of the foregoing, the carbonation chamber is at approximately one atmosphere pressure.

In various embodiments, set forth herein is a system comprising: a gas conditioning apparatus; a flow-through chamber; and an instrument configured to send control signals to the gas conditioning apparatus wherein the flow-through chamber is at atmospheric pressure and comprises; a processor and a storage medium with instructions operable when executed for flowing a CO₂-containing gas from a gas conditioning apparatus into a carbonation chamber comprising at least one green body; measuring, in real-time, temperature, relative humidity, CO₂ concentration, gas flow rate, gas flow direction, or a combination thereof, in the carbonation chamber to provide a measurement; inputting the measurement into a regression model to determine the extent of carbonation of the at least one green body; sending a control signal to the gas conditioning apparatus while flowing the CO₂-containing gas to: actively condition the CO₂-containing gas based on the extent of carbonation; and effect a multi-step carbonation process.

In some embodiments, including any of the foregoing, the instrument is configured to send control signals to the gas conditioning apparatus to adjust actively temperature, relative humidity, CO₂ concentration, gas velocity, or combinations thereof, in a CO₂-containing gas moving through the gas conditioning apparatus.

In some embodiments, including any of the foregoing, the system includes at least one gas recirculation line coupled to the flow-through chamber configured to recirculate the CO₂-containing gas out of the flow-through chamber and back into the flow-through chamber.

In some embodiments, including any of the foregoing, the temperature of the CO₂-containing gas stream in the flow-through chamber is higher than the temperature of the at least one green body.

In some embodiments, including any of the foregoing, the flow-through chamber does not comprise an external heating jacket.

In some embodiments, including any of the foregoing, the curing chamber comprises a remote balancing damper to change gas flow direction.

In some embodiments, including any of the foregoing, the flow-through chamber comprises at least one curing chamber

In some embodiments, including any of the foregoing, the flow-through chamber is made of concrete.

In some embodiments, including any of the foregoing, the flow-through chamber is made of a flexible material.

In some embodiments, including any of the foregoing, the flow-through chamber is a tent.

In some embodiments, including any of the foregoing, the flow-through chamber is a polymer-based enclosure.

In some embodiments, including any of the foregoing, the at least one green body comprises at least one member selected from the group consisting of hydrated lime, portland cement, coal combustion residues, recycled concrete aggregates, natural pozzolans, other industrial solid wastes, or a combination thereof.

In some embodiments, including any of the foregoing, the green bodies further comprise coal slag, lime kiln dust, cement kiln dust, other industrial alkaline solid wastes, or a combination thereof.

In some embodiments, including any of the foregoing, the processes herein include active conditioning that achieves superior material performance, such as strength, at the minimum energy cost.

In some embodiments, including any of the foregoing, the processes herein include active conditioning that achieves superior material performance, such as strength, while minimizing energy emissions.

### Examples

Unless specified otherwise, particle size distribution (PSD) is measured using static light scattering (SLS) using a Beckman Coulter LS13-320 particle sizing apparatus fitted with a 750 nm light source.

Unless specified otherwise, compositional analysis is performed using X-ray diffraction (XRD) and/or X-ray fluorescence (XRF).

Unless specified otherwise, specific surface area and pore volume are determined using BET (Brunauer-Emmett-Teller) and BJH (Barrett-Joyner-Halenda) measurements. BET analysis determines the specific surface area based on a monolayer adsorption of nitrogen, and the BJH analysis would determine the pore volume based on a multilayer adsorption of nitrogen.

Two independent methods can be applied to quantify the mineralized CO₂ by project proponents: (1) instrumentation that calculates the carbon balance between gas inlets and gas outlets of the curing chamber, and (2) thermogravimetric analysis (TGA) to measure the carbon content of the cured concrete products. The latter method can be used additionally to verify the carbon balance measured by curing system instrumentation such as sensors and system controllers.

Method I: The curing system's instrumentation measures CO₂ concentration, flow rates, temperature, and relative humidity of gas at the inlet and outlet points from the curing chambers. The CO₂ uptake is determined by the CO₂ mass flow rate difference between the curing chamber inlet and the curing chamber outlet. The CO₂ utilization efficiency % is then determined as the average CO₂ uptake divided by the CO₂ input over the carbonation curing period. This method features real-time monitoring of carbon balance. Carbon balance is an indication of CO₂ utilization efficiency. Carbon balance describes the relationship between the amount of carbon entering the carbonation chamber, in the form of CO₂, relative to the amount of carbon exiting the carbonation chamber.

Thermogravimetric analysis (TGA) is used to assess the extent of CO₂ uptake in a concrete product. TGA is a technique in which the mass and decomposition of a substance is monitored as a function of temperature or time as the sample specimen is subjected to a controlled temperature program in a controlled atmosphere.

Unless specified otherwise, thermogravimetric analysis (TGA) is used to assess carbonation extent and CO₂ uptake of carbonated materials. TGA is used to measure the amount of CaCO₃ formed in a material as a consequence of that material being carbonated by reacting with CO₂.

### Example 1—Shortered Curing Cycle and Material Performance Through Processing Condition Control

Example 1: This Example demonstrates the field performance of a carbonation curing system that was used to produce concrete components using dilute coal-fired flue gas streams at ambient pressure. This Example shows that processing condition optimization during carbonation curing (also referred herein as active processing or active carbonation) can reduce system energy demand, shorten curing duration, enhance CO₂ uptake, and improve material performance.

This Example demonstrates system energy and material performance by eliminating the drying cycle and shortening the curing cycle. This was achieved by adjusting processing conditions during carbonation curing in an active manner. This included using sensors in the curing chamber and sensors on the curing green bodies and concrete products. This also included using a system controller to actively adjust the CO₂-containing gas during the carbonation curing.

Constant processing conditions was used during carbonation curing in a separate batch to compare with the active processing conditions outlined above and specified below.

The two-step drying-carbonation process included: step 1: air drying using air for 12 hours at 65° C. and 10% RH before carbonation; then step 2: carbonation using CO₂-containng gas stream at 65° C. and 10% RH. However, for the single step carbonation process, the air drying before carbonation was eliminated and only 24 hours carbonation step was applied. For the single step carbonation process, the CO₂-containng gas stream at 65° C. and 10% RH was used at the beginning of process and it was conditioned by reducing gas temperature and RH during carbonation curing time based on temperature and relative humidity changes of concretes inside of the curing chamber as well as the difference between relative humidity and temperature of gas at the inlet and outlet of curing chamber.

The curing system included two major components. One was the gas processing apparatus, which conditioned (i.e., adjusted) the temperature, relative humidity, and flow rate of the incoming flue gas. The other was the curing chamber, within which the conditioned incoming flue gas contacted and reacted with the concrete components. The curing system included heat exchangers, heaters, blowers and pumps, and instrument sensors. See, for example, FIGS. 1A and 1B.

FIG. 1A shows a schematic carbonation curing system, 100, which is a model for the curing system used in this Example. The carbonation curing system, 100, included a gas conditioning apparatus, 101. The gas conditioning apparatus, 101, included heat exchangers, heaters, blowers and pumps, and instrument sensors, which were used to monitor the temperature of the flue gas, the humidity of the flue gas, and the flow rate of the flue gas, and the CO₂ concentration of the flue gas. The gas conditioning apparatus, 101, also modified the flue gas by heating the flue gas, dehumidifying the flue gas, and blowing flue gas. The carbonation curing system, 100, includes curing chambers, 108 and 109.

The gas conditioning apparatus, 101, produced conditioned flue gas which exited through pipe, 103, and into the curing chambers, 108 and 109. Also included was a recycle loop which included filter, 106, pipe, 105, blower, 104, and return pipe, 102. The return pipe, 102, returned CO₂ from inside the curing chambers, 108 and 109, to the gas conditioning apparatus, 101. The gas conditioning apparatus, 101, was controlled by controllers, 107. Also shown are gas diffusers, 110 and 111, on the floor and ceiling, respectively. The recycle loop could independently feed each chamber, 108 and 109.

FIG. 1B shows a schematic carbonation curing system, 110, which is a model for the curing system used in this Example. The carbonation curing system, 110, included curing chamber, 112. Curing chamber, 112, is equivalent to curing chamber, 108 or 109, in FIG. 1A. Concrete components, 113, were stacked on racks, 111, and placed inside the curing chamber, 112.

The curing system included a carbonation chamber that was built from a modified open-sided 40′ (forty foot) shipping container. In the modified open-sided shipping container, about 850 concrete blocks (≈15 metric tons of concrete per production batch) were cured. These concrete blocks are represented by concrete components, 113, in FIG. 1B.

FIG. 1C shows self-sensing instrumental system inside of the curing chamber. The self-sensing instrumentation system monitored temperature and relative humidity of the chamber environment at the gas inlet and outlet of the curing chamber. The self-sensing instrumentation system also monitored gas velocity inside the chamber. The self-sensing instrumentation system monitored temperature, relative humidity and mass change of concrete blocks as well during the carbonation curing period. The instrumentation sensors include thermocouples, flow velocity sensors, relative humidity sensors, and weighing scales. In some examples, the instrumentation sensors also include CO₂ measurement sensors.

Sensors were also included in the gas conditioning apparatus at varying locations to monitor temperature, relative humidity, gas flow rate, and the CO₂ concentration of the incoming flue gas and the outgoing conditioned flue gas before the outgoing conditioned flue gas entered the curing chamber. Sensors were also included in the curing chamber to monitor temperature, relative humidity, the CO₂ concentration, and gradients in gas properties, at various locations. Furthermore, some representative concrete components inside of curing chamber were selected and instrumented with sensors to monitor internal temperature and relative humidity during the curing process. See FIGS. 1D-1G which shows these sensors. All these sensors and instruments were connected to the system controller. This provided real-time communication between the sensors in the chamber and on the concrete blocks and the gas conditioning apparatus. This allowed for the active adjustment of gas processing conditions during the curing cycle. This, in turn, improved the processing energy without sacrificing material performance, as demonstrated by the data below.

FIG. 1D shows a curing chamber, 400. Temperature sensors, 401 and 402, are shown.

FIG. 1E shows a curing chamber (not labeled). Sensors, 403, is shown.

FIG. 1F shows a curing chamber, 404. Concrete components with sensors, 405 and 406, are shown.

FIG. 1G shows a curing chamber (not labeled). The curing chamber has three columns labeled Bay 1, Bay 2, and Bay 3. Also labeled are Shelves 1 through 5. Concrete components are shown by not labeled.

The real-time monitoring of internal temperature and relative humidity of concrete components, as shown in FIG. 1C, inside of the curing chamber was performed to apply time-based changes in processing conditions and determine the transition time. This is schematically shown in FIG. 1G which shows concrete blocks T (Top), M (Middle), and B (Bottom). The T, M, and B, blocks were fitted with sensors to monitor temperature and relative humidity at different heights in the chamber. In a first step, a flue gas stream was introduced to a gas conditioning skid. Depending on the moisture content of the incoming flue gas, the gas conditioning skid dehumidified (e.g., near or lower than the dew point) the gas stream by passing the flue gas through a heat exchanger which included circulating chilled water. The incoming flue gas was cooled to ensure dehumidification. Next, the flue gas was passed through heaters to heat the flue gas from about 20° C. to about 80° C. This produced the conditioned flue gas. Next, the conditioned flue gas was injected into the carbonation chamber.

This Example shows that by actively conditioning the flue gas temperature and humidity, then CO₂ diffusion within the microstructure of the concrete blocks was enhanced. The progressive evaporation (i.e., continuous evaporation) of water, which was contained in the pores of the concrete blocks, enhanced CO₂ sequestration. The active conditioning eliminated the need for a two-step process because of this progressive evaporation which enhanced CO₂ sequestration.

The curing system in this Example was designed to feature varying processing conditions such as air drying, carbonation, and humidification cycles. The air-drying step could be applied to adjust pore water saturation within the concrete to enhance gas transport prior to carbonation step. The carbonation step in which CO₂ is sequestered in the concrete components. The humidification step includes introducing water into the concrete components to continue hydration reactions in the concrete components.

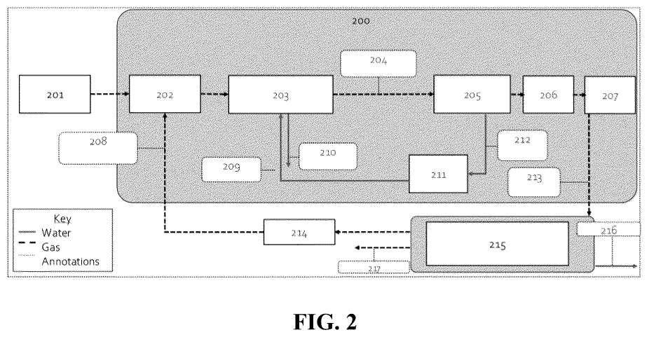

A summary of the sequential processing steps employed in the carbonation curing system in this Example are shown in FIG. 2. FIG. 2 shows a primary flue gas stream, 201. The primary flue gas stream, 201, enters a blower, 202, and then a first heat exchanger, 203, for cooling and water separation. At the blower, 202, a CO₂ lean gas, 208, may be recycled into the system, 200. The blower, heater exchangers, heaters, and humidifier are used to condition the flue gas stream. Condition means to adjust the temperature, relative humidity, flow rate, or a combination thereof. The conditioning was done to increase the rate of carbonation within the curing chamber, 215. 204 shows cooled and saturated gas which then flows to the second heat exchanger, 205, and heater, 206, and humidifier (or de-humidifier), 207. The humidifier (or de-humidifier), 207, produced a condensate, 216. The flow-through chamber for carbonation curing is shown as 215. Exiting a vent in the flow-through chamber, 215, is exhaust, 217. Exiting a vent in the flow-through chamber, 215, is also CO₂ lean gas which moves through blower, 214. Also shown is chilled water, 209, and condensed water, 210. Also shown is a chiller, 211. Also shown is a cooled water, 212. Also shown is hot, dry gas, 213.

The ability of the carbonation curing system to produce concrete components (herein “the concrete block”) was field demonstrated at the Integrated Test Center in Gillette, WY. The operational runs included using dilute CO₂-containing flue gas which was directly produced from a coal-fired power plant. In total, around 155 tons of concrete blocks were produced.

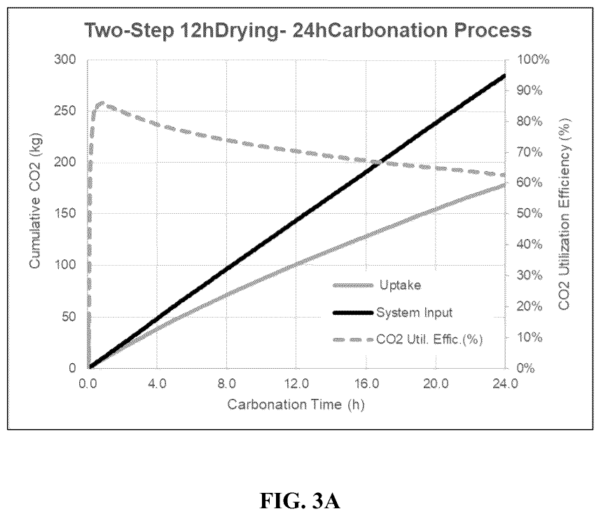

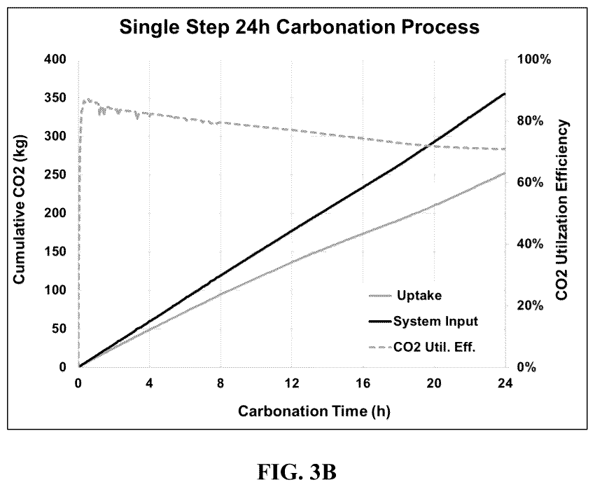

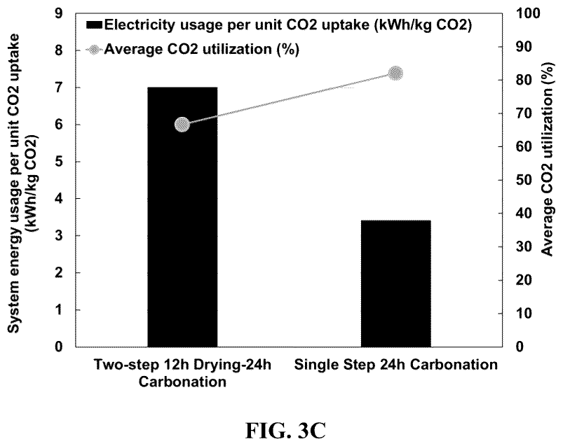

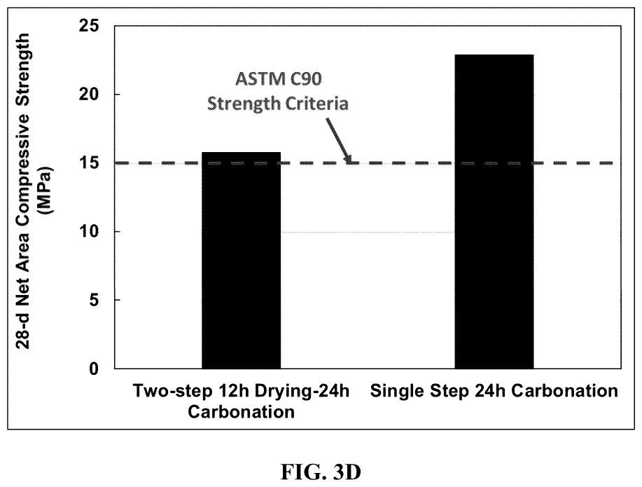

CO₂ sequestration was measured using system instrumentation sensors and was verified through thermogravimetric analysis of concrete products following curing completion. The CO₂ utilization efficiency % was determined as the average CO₂ uptake divided by the CO₂ input over the carbonation period. The CO₂ input into the system was calculated by calculating the mass flow rate of CO₂ into the system, from the measurements of CO₂ concentration and flow rate at the system inlet. FIGS. 3A and 3B compares the cumulative CO₂ input into the system, cumulative CO₂ uptake into the carbonated concrete blocks, and CO₂ utilization efficiency during carbonation curing for two-step 12 h drying-24 h carbonation curing and single step 24-carbonation curing. The two-step included an initial, separate drying step. The single step did not because active conditioning was used.

The carbonation curing system in this Example demonstrated that actively adjusting process conditions during carbonation curing resulted in the elimination of 12-h drying step prior to carbonation and resulted in greater carbonation utilization efficiency. This resulted by adjusting temperature and relative humidity actively during the carbonation curing using the self-sensing instrumentation system. This is shown in FIG. 3C. As such, the CO₂ uptake per system energy unit improved substantially through processing condition optimization using active processing as compared to not using active processing. FIG. 3D shows that material performance (compressive strength) was also improved as a result of greater CO₂ uptake and elimination of the drying cycle. The drying cycle can cause excessive drying of concrete and hence suppression of hydration reaction.

Example 1 demonstrates system energy and material performance optimization by elimination of the drying cycle and by using a shorter curing cycle. This is achieved by actively adjusting processing conditions during carbonation using active conditioning.

### Example 2—Adjusting Processing Conditions During Carbonation Cycle in Carbonation Curing System

This Example demonstrates the use of the active curing system by actively adjusting processing conditions during carbonation curing cycle to reduce process energy demand, shorten curing time, and enhance material performance. The same curing chamber as in Example 1 was used. This example compares the performance of active and passive curing methods during carbonation curing. No separate drying step was adopted before carbonation for both cases.

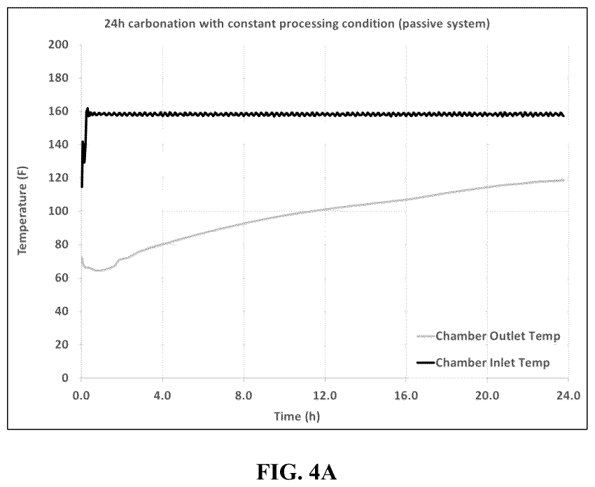

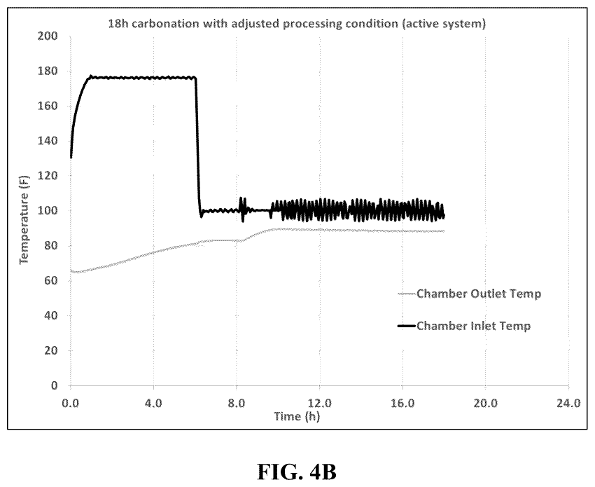

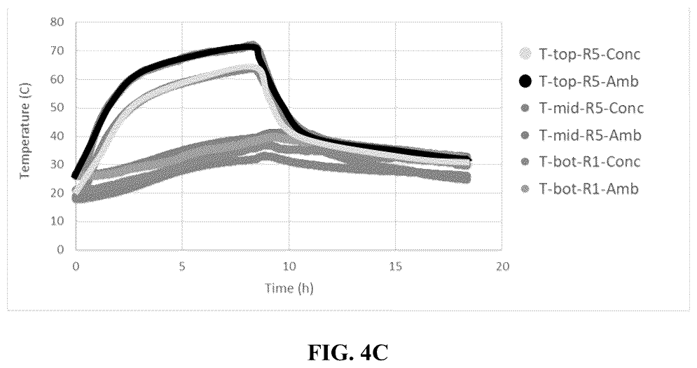

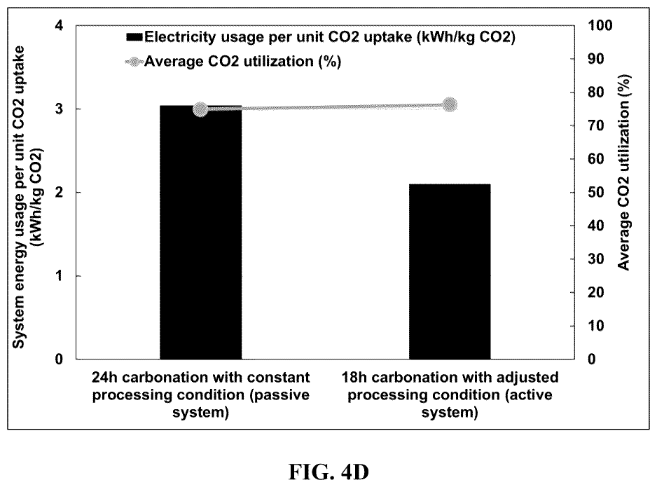

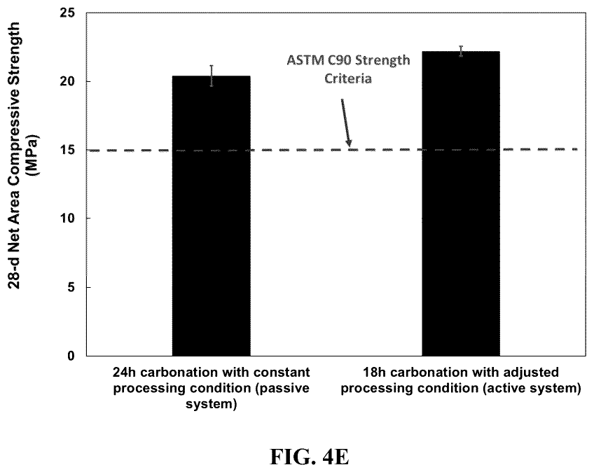

The temperature profile of the curing chamber inlet and curing chamber outlet for passive (constant processing condition) and active (adjusting processing conditions) curing systems are shown in FIGS. 4A and 4B. The same curing chamber as in Example 1 was used. The evolution of the internal temperature of the concrete, as well as the temperature of the curing chamber, is shown in FIG. 4C. Processing conditions were adjusted to refine/improve the system energy and material performance. FIG. 4C shows the temperature measured from a top concrete block sensor (T-top-R5-Conc). FIG. 4C shows the temperature measured from a top sensor (T-top-R5-Amb). FIG. 4C shows the temperature measured from a middle concrete block sensor (T-mid-R3-Conc). FIG. 4C shows the temperature measured from a middle sensor (T-mid-R3-Amb). FIG. 4C shows the temperature measured from a bottom concrete block sensor (T-bot-R1-Conc). FIG. 4C shows the temperature measured from a bottom sensor (T-top-R1-Amb).

FIGS. 4D and 4E show that it was possible to minimize the energy expended and shorten carbonation time while optimizing the carbonation rate and improving material performance using active processing. Based on self-sensing instrumentation system in concrete products inside of the chamber and instrumentation of the curing chambers, the processing conditions were actively adjusted by changing the temperature set-points of the chiller and heater. Hot and dry CO₂-containing flue gas stream was initially used to elevate concrete temperature and reduce moisture saturation level of the concrete components via water evaporation from the pores in the concrete components. This facilitated gas transport and enhanced carbonation kinetic. With time, the relative humidity (RH) of the recycle line declined. This means that the RH conditioning in the latter part of the run was relaxed so less gas cooling duty (less chiller duty) and less gas-reheating duty are required. Since the gas was drier than before, the energy expended in reducing the curing chamber inlet RH was reduced. Since the gas was cooled less, it took less energy to heat it back up to temperatures for carbonation.

In this Example, when the concrete temperature reached 40° C. and the internal relative humidity dropped to 80%, the heater temperature set point reduced and the chiller outlet temperature set point increased to create a more humid and cooler CO₂ stream for the rest of the carbonation process. Further, total gas flow rate entering the curing chamber decreased. This was accomplished by reducing the recycle ratio that enabled more system energy reduction for gas processing. Reducing the recycle ratio resulted in less CO₂ dilution in the incoming gas stream. The CO₂ concentration of the gas stream entering the curing chamber therefore increased. These process improvements yielded an appreciable reduction in energy usage without sacrificing CO₂ uptake performance and enhancing material performance. This was accomplished using active adjustment of the conditions for the carbonation-hydration reactions.

### Example 3: Effect of Chiller Setpoint Temperature Adjustment on System Curing Energy Usage

This Example shows the effect of chiller set point temperature adjustment on process energy demand.

As described in Example 2, above, the incoming flue gas is cooled and then heated to the desired temperature set point before being injected into the curing chamber. This process removes water and adjusts the RH of flue gas. Generally, a low temperature at the chiller outlet ensures maximum water separation in the form of liquid water. But this results in a higher chiller utility energy load and an additional penalty on the heater to heat the flue gas from a lower starting temperature back to a temperature useful for carbonation. To study the effect of chiller outlet temperature on heater and chiller energy duty, a sensitivity analysis was performed using an ASPEN simulation of the overall process. The results are plotted in FIG. 5. It is evident that decreasing the chiller outlet temperature (left side of plot) resulted in an increase in the amount of liquid water separated in the chiller (blue line). This helps to reduce the RH of the curing chamber inlet (green line). However, the heating and cooling utilities increase too (pink and purple lines labeled Heater Duty and Chiller Duty). This graph shows that a low cooling duty at the chiller (right side of the plot) results in a gas of RH of ˜20% entering the curing chamber. Thus, the only utility required is to heat the gas to the desired temperature for carbonation. If ˜15% inlet RH is acceptable, then the chiller outlet temperature can be increased to about 29° C., saving about 30% on overall utilities. A more drastic change is to increase the chiller outlet temperature to 40° C. If about 20% RH is acceptable, then the chiller outlet temperature can be increased to 40° C., reducing ˜50% in overall utilities.

### Example 4: Compliance Performance Verification of Carbonated Concrete Components Produced Under Active Curing System

This Example shows the compliance performance verification of the carbonated concrete components made in Example 1.

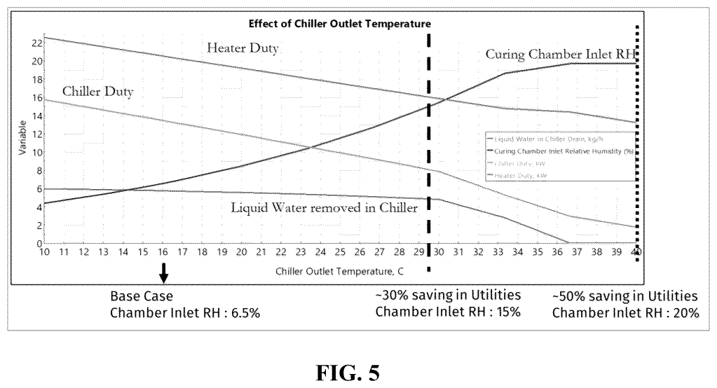

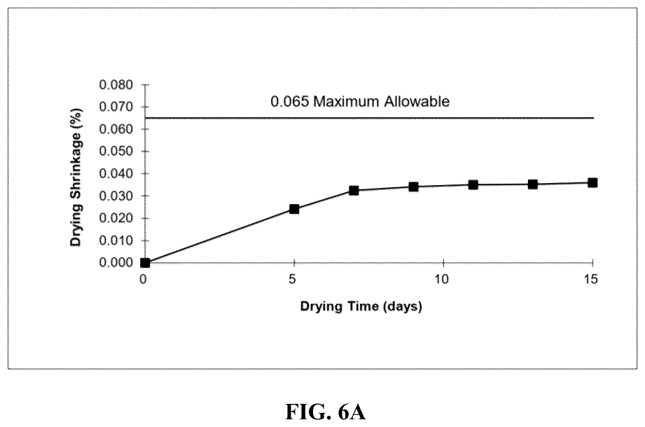

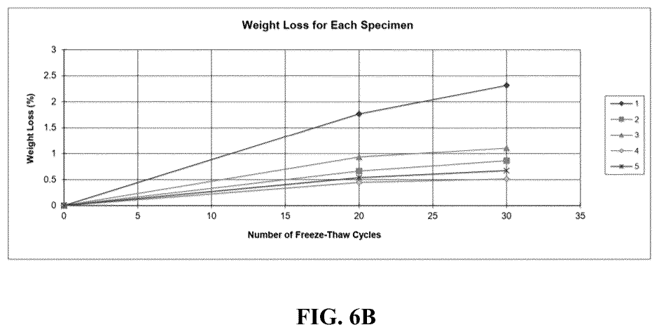

All the carbonated concrete masonry units produced during field testing (in Example 1) were hollow concrete masonry units having nominal dimensions of 8×8×16 inches. (203×203×406 mm) and specified dimensions of 7.625×7.625×15.625 inches. (194×194×387 mm). All tested concrete blocks were cured using the carbonation curing system in Example 1. The concrete blocks were contacted with 12% CO₂ concentration in the curing chamber using a coal-fired flue gas stream. These units were tested to verify compliance with ASTM C90-14, Standard Specification for Loadbearing Concrete Masonry Units. Compressive strength, absorption, density, and dimensional tolerances were determined in accordance with ASTM C140/C140M-15, Standard Test Methods for Sampling and Testing Concrete Masonry Units and Related Units. Linear drying shrinkage of the carbonated blocks was evaluated in accordance with ASTM C426-16, Standard Test Method for Linear Drying Shrinkage of Concrete Masonry Units. The results of these tests are summarized in Table 1 and the linear drying shrinkage profile is depicted in FIG. 6A.

TABLE 1
Evaluation of CO₂ Concrete-Based Masonry Units

| | | |
|---|---|---|
| Property | Measured Value | Required Property |

ASTM C140/C140M-15 Properties

| | | |
|---|---|---|
| Width, in. (mm) | 7.61 (193.5) | +/−⅛ (3) from specified |
| Height, in. (mm) | 7.60 (193.0) | +/−⅛ (3) from specified |
| Length, in. (mm) | 15.56 (396.2) | +/−⅛ (3) from specified |
| Face Shell Thickness, in. (mm) | 1.28 (32.5) | 1.25 (32) minimum |
| Web Thickness, in. (mm) | 1.23 (31.2) | 0.75 (19) minimum |
| Normalized Web Area, in.²/ft² (mm²/m²) | 31.5 (218,750) | 6.5 (45,140) minimum |
| Percent Solid, % | 52.6 | NA |
| Density, lb/ft³ (kg/m³) | 125.9 (2016.7) | NA |
| Absorption, lb/ft³ (kg/m³) | 10.4 (166.6) | 13.0 (208) maximum |
| Net Area Compressive Strength, psi (MPa) | 3,710 (25.6) | 2,000 (13.8) minimum |

ASTM C426-16 Properties

| | | |
|---|---|---|
| Drying Shrinkage, % | 0.035 | 0.065 maximum |

### Example 5: Freeze-Thaw Durability of Carbonated Concrete Components Produced Under Active Curing System

This Example shows the freeze-thaw durability of the carbonated concrete components made in Example 1.

To assess unit durability, the carbonated concrete masonry units were subjected to freezing and thawing conditions in tap water in accordance with ASTM C1262/C1262M-18, Standard Test Method for Evaluating the Freeze-Thaw Durability of Dry-Cast Segmental Retaining Wall Units and Related Concrete Unit. As per AC520 Section 4.5.2, the mass loss for each of the five test specimens at the conclusion of 20 cycles shall not exceed 1 percent of its initial weight. If this condition at the end of 20 cycles is not met, then the weight loss of each of four of the five test specimens at the conclusion of 30 cycles shall not exceed 1.5 percent of its initial weight. The CO₂ concrete-based blocks from Example 1 only had one coupon exceeding the permitted mass loss at both the 20 and 30 cycle reading, thus satisfying the freeze/thaw performance criteria of AC520. Detailed results of the freeze-thaw test are shown in FIG. 6B.

### Example 6: Modulus of Elasticity of Carbonated Concrete Components Produced Under Active Curing System

This Example shows the modulus of elasticity of the carbonated concrete components made in Example 1.

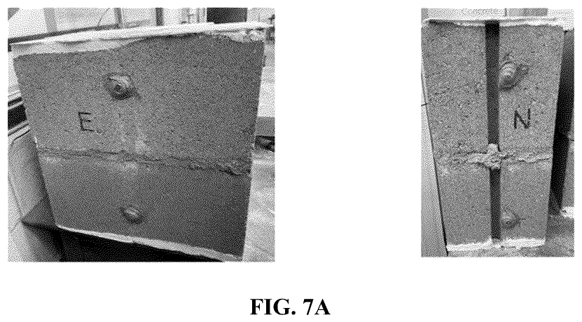

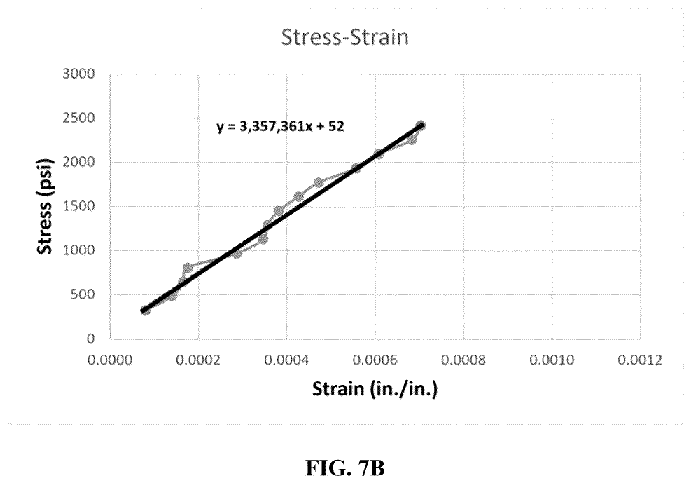

The modulus of elasticity of the carbonated concrete blocks was evaluated on prisms constructed in accordance with ASTM C1314-18, Standard Test Method for Compressive Strength of Masonry Prisms. Prisms were grouted and constructed using concrete blocks and Type M PCL mortar. Prisms were cured for 28 days prior to testing. Gauge plugs were installed on all four sides of the block with a gauge length of approximately 10 in. (254 mm). Dial gauges having a resolution of 0.0001 in. (0.002 mm) were used to measure the displacements. See FIG. 7A. Chord modulus was determined using a single loading cycle for each prism in accordance with ASTM E111-17, Standard Test Method for Young's Modulus, Tangent Modulus, and Chord Modulus. As per AC520 Section 4.7.3, the modulus of elasticity of each specimen shall be at least equal to 900f′ₘ. The chord modulus was calculated between 0.05 and 0.33 of the estimated maximum compressive strength of each prism. FIG. 7B shows the stress-strain curves. In accordance with TMS 602-16, Specification for Masonry Structures, the assembly compressive strength for these prisms is permitted to be taken equal to 2,680 psi (18.5 MPa). Using a best-fit linear relationship, the modulus of elasticity for the two prisms with a compressive strength of 2,680 psi (18.5 MPa) is 1,253f′ₘ and 1,390f′ₘ.

### Example 8—Active Carbonation Using Regression Modeling

This Example demonstrates how to develop a regression model using empirically determined carbonation rates and carbonation amounts under various processing conditions. The regression model is useful for identifying the amount of carbonation that is occurring (i.e., the rate of carbonation) as a function of multiple variables such as the temperature in the carbonation chamber, relative humidity, CO₂ concentration, gas velocity, or a combination thereof. Based on this model, the amount of carbonation that occurs during a carbonation process can be increased or decreased by toggling the temperature in the carbonation chamber, relative humidity, CO₂ concentration, gas velocity, or a combination thereof, in accordance with the regression model. There is an energy cost associated with changing the temperature in the carbonation chamber, relative humidity, CO₂ concentration, gas velocity, or a combination thereof, in a carbonation chamber. And the amount of energy needed to change the temperature in the carbonation chamber, relative humidity, CO₂ concentration, gas velocity, or a combination thereof, in a carbonation chamber, can be calculated. The amount of energy needed can also be equated with an amount of CO₂ that would be released, for example by burning fuel to produce energy. The amount of CO₂ sequestered by carbonation can also be monitored during a carbonation process using the regression model. Based on this, a carbonation process can occur in which the carbonation rate is maximized while still maintaining net zero carbon emissions when considering the amount of CO₂ produced to create the energy needed to condition the CO₂-containing gas in the carbonation process and the amount of CO₂ sequestered as concrete.

This Example demonstrates how to develop a regression model and then use that regression model to dynamically control carbonation curing processes.

### Part One: Carbonation Based on Carbonation Conditions

An exemplary binary binder (i.e., precursor) component useful for making concrete by carbonation curing was selected.

Table 2 below shows the oxide composition of the binary binder component which included cement and fly ash as follows:

TABLE 2
Composition (mass %) of the cement Type III and Class C Fly ash.

| Binder | Oxide mass composition (mass. %) | | | | | | | |
|---|---|---|---|---|---|---|---|---|
| component | SiO₂ | Al₂O₃ | Fe₂O₃ | SO₃ | CaO | Na₂O | MgO | K₂O |
| Cement | 20.3 | 4.7 | 3.7 | 3.0 | 63.4 | 0.1 | 1.1 | 0.7 |
| Fly ash | 38.50 | 20.05 | 5.96 | 1.48 | 22.28 | 1.64 | 5.04 | 0.62 |

Dry-cast concrete was mixed at a low water-to-binder mass ratio (w/b=0.29, i.e., having zero slump) and then consolidated by mechanical compaction. The concrete formulation used consisted of 10 mass % Type III OPC, 5 mass % portlandite (93% purity, as measured by thermogravimetric analysis), 5 mass % Class C fly ash, and fine and coarse aggregates (22 mass % coarse with a size range of: 1.18-4.75 mm, and 58 mass % fine river sand compliant with ASTM C33.

An experimental matrix as shown in Table 3 was tested in duplicate to identify the amount of carbonation occurring under at least twelve carbonation conditions.

TABLE 3

| | | Target | |
|---|---|---|---|
| | [CO₂] | RH | T |
| Sample | (%) | (%) | (° C.) |
| A | 9 | 45 | 43 |
| B | 9 | 45 | 43 |
| C | 4 | 10 | 20 |
| D | 4 | 80 | 65 |
| E | 9 | 10 | 43 |
| F | 14 | 80 | 20 |
| G | 14 | 10 | 65 |
| H | 9 | 45 | 11 |
| I | 9 | 45 | 74 |
| J | 2 | 45 | 43 |
| K | 16 | 45 | 43 |
| L | 9 | 95 | 43 |

The above experimental matrix of experiments was performed in a carbonation chamber. Concentrated CO₂ (purity>99.5%) and compressed air were mixed using mass flow controllers (Alicat) to achieve the specified CO₂ concentration following which the gas stream was input in the bench-scale carbonation reactor (as shown in FIG. 8). The temperature and CO₂ concentration in the reactor were measured continuously using Dracal USB-DXC220 sensors. The relative humidity (RH) was controlled by bubbling the gas through two wash bottles placed in series in convective ovens (Quincy Lab Inc.). The temperature of one oven, Oven A, was adjusted to achieve the desired gas RH, and another oven, Oven B, was used to control the target temperature. To quantify the extent of carbonation, a hand-held rotary drill was used to extract powder samples up to its mid-depth (38 mm). Powdered samples were collected at 0, 2, 3, 4, 6 and 24 hours of carbonation. Thereafter, the extracted powder was collected and immersed in isopropyl alcohol (IPA) and continuously stirred for 24 hours to arrest the hydration. The powder was then collected using vacuum filtration, dried in a desiccator, and then analyzed using thermogravimetric analysis (TGA). TGA was carried out using an STA 6000 (Perkin Elmer). A temperature range of 35° C. to 950° C. and a heating rate of 15° C./min were used in the presence of ultra-high purity N₂ gas (purity>99.99%) at a flow rate of 20 mL/min. The CO₂ content (mass % of total solids) in the sample was quantified by using the following equation to calculate the difference in the residual mass at a temperature range between 600 to 900° C. at which mineral carbonates (such as CaCO₃) decompose:

$${m}_{CO 2 , \%} = \frac{{m}_{( 600 - 900 ° C )}}{{m}_{solid}} \times 100 \qquad Eq . 1$$

where m_{CO2} is the mass percentage of CO₂ determined from TGA (mass %), m_{(600-900° C.)} is the mass loss between 600 to 900° C. (mg), and m_{solid} is the mass of the solid sample (mg). The initial content of CO₂ in the pre-carbonated samples was subtracted from the post-carbonation assessment to account for CO₂ that was specifically taken up during the carbonation process.

### Part Two: Modeling

A linear regression model for carbonate formation was made based on the above experiments. The analysis of variance (ANOVA) indicated that the model was significant (P-value=0.0023<0.05). The model predictions were compared to actual results and the correlation had an R-squared value of 0.82.

A parametric approach was followed to assess the influence of processing conditions on the CO₂ uptake of a dry-cast concrete component. Design-Expert 7, which applies a Design-of-Experiments (DoE) method, was used to generate the experimental matrix and model the results using a response surface methodology (RSM). Stat-Ease, Inc., Design-Expert 7.0 User's Guide, 2005. Central composite design (CCD) was used with minimal point designs to limit the number of experiments required to generate the regression model. In the CCD method, the center point (i.e., 0) represents the middle value of each parameter. For the factorial points, each variable was changed to the upper limit or the lower limit. The distance from the center point to the upper and lower limits of each variable was multiplied by a, a factor used to determine the distance from the center point to the axial points.

A regression model was developed to link the extent of CO₂ uptake to the process variables, [CO₂], T and RH. This linear model is as described in Equation (1):

$${X}_{m} = 0.166 + 0.0208 \times [ {CO}_{2} ] - 0.0014 \times R H + 0.0012 \times T \qquad Eq . 1$$

where, the modeled extent of conversion Xₘ (conversion, unitless) is the measured CO₂ uptake divided by the theoretical (stoichiometric) CO₂ uptake (4.9 mass % of the total solid mass). Since the RH within the reactor showed fluctuations within +/−15%, the average RH over the course of the 24 h carbonation cycle was used as a model input, while the measured temperature (within +/−1° C.) was specified as is. The analysis of variance (ANOVA) indicated that the model was significant (P-value=0.0023) as presented in Table 4. The model predictions were compared to the experimentally measured extent of conversion (Xₑ, unitless). In general, an acceptable level of agreement between the measured and modeled results was noted with an R-squared value of 0.82.

TABLE 4
ANOVA results for the developed regression model.

| | | Degrees | Mean | | |
|---|---|---|---|---|---|
| | Sum of | of | squared | F- | p-value |
| Source | squares | freedom | error | value | prob > F |
| Model | 0.102 | 3 | 0.034 | 12.35 | 0.0023 |
| [CO₂] | 0.084 | 1 | 0.084 | 30.52 | 0.0006 |
| RH | 0.008 | 1 | 0.008 | 2.99 | 0.0122 |
| T | 0.004 | 1 | 0.004 | 1.58 | 0.0243 |
| Residual | 0.022 | 8 | 0.003 | | |
| Corrected | 0.12 | 11 | | | |
| total | | | | | |

Thermodynamic modelling was used to predict the maximum CO₂ uptake of the cement to contribute to the maximum possible CO₂ uptake after 24 hours of carbonation. For the modeling, an estimated degree of hydration of the cement at a given temperature is required as input into the simulations. For this, an estimated total degree of hydration of the cement was used based on the heat release from isothermal calorimetry. Once the degree of hydration was determined, the calculated mass fractions of cement hydrates can be predicted, and the respective maximum CO₂ uptakes associated with these phases can be calculated. The heat release was used to estimate the time-dependent degree of cement hydration θ(t) (mass %) as

$$θ ( t ) = \frac{Q ( t )}{{C}_{b} {ΔH}_{hyd}} \qquad Eq . 2$$

where Q (t) is the cumulative heat release as a function of time (J), C_{b} is the binder content (kg binder/kg specimen), and ΔH_{hyd} is the ultimate heat release due to OPC hydration, given by

$${ΔH}_{hyd} = {m}_{{C}_{3} S} {ΔH}_{{C}_{3} S} + {m}_{{C}_{2} S} {ΔH}_{{C}_{2} S} + {m}_{{C}_{3} A} {ΔH}_{{C}_{3} A} + {m}_{{C}_{4} AF} {ΔH}_{{C}_{4} AF} \qquad Eq . 3$$

and where mi is the mass fraction of the i^{th} phase within the cement, and ΔHᵢ is its reaction enthalpy (J/g). The composition of the cement was estimated via X-ray fluorescence (XRF) analysis coupled with Bogue calculations as 59.11% C₃S, 13.46% C₂S, 6.11% C₃A and 11.23% C₄AF, on a mass basis. The ΔHᵢ values were sourced from the literature and summarized in Table 4.

Based on the carbonation conditions (variable T, [CO₂] and RH), the degree of hydration of the cement will vary across the carbonation period. However, 24 hours and 25° C. were chosen as the basis for the degree of hydration to be selected for the cement contribution to the maximum CO₂ uptake. The degree of hydration of the Type-III cement at 24 h and 25° C. was determined to be 46%. See Table 5.

TABLE 5
Values used for the degree of hydration calculations based
on isothermal calorimetry of cement. Clinker mass fractions
were determined from Bogue's calculations.

| | Clinker phase | | | |
|---|---|---|---|---|
| Degree of hydration component | C₃S | C₂S | C₃A | C₄AF |
| Heat of hydration (AHᵢ-J/g) | 510 | 247 | 1356 | 427 |
| Mass (%) | 59.11 | 13.46 | 6.11 | 11.23 |
| Change in enthalpy contribution | 306 | 34.58 | 81.36 | 46.97 |
| (AHᵢ-J/g Cement) | | | | |

Cement hydration caused precipitation of Ca-rich hydrate phases capable of carbonation. Formation of amorphous calcium silicate hydrates (C—S—H), calcium hydroxide (portlandite—Ca(OH)₂) and ettringite (3CaO·Al₂O₃·CaSO₄·34H₂O) also occurred. The carbonation reactions shown in Eq.4-7, below, demonstrate the potential CO₂ uptake on a mass basis for each component, ranging from 0.04-to-0.59 gCO₂/g solid.

$$\begin{matrix}x CaO \cdot {y SiO}_{2} \cdot {n H}_{2} O + {x CO}_{2} \to {x CaCO}_{3} \cdot {y SiO}_{2} \cdot {n H}_{2} O & 0.23 - 0.39 {gCO}_{2} / g\end{matrix} \qquad Eq . 4$$

$$\begin{matrix}x CaO \cdot {y SiO}_{2} \cdot {n H}_{2} O + {x CO}_{2} \to {x CaCO}_{3} + {y SiO}_{2} + {n H}_{2} O & 0.23 - 0.39 {gCO}_{2} / g\end{matrix} \qquad Eq . 5$$

$$\begin{matrix}{Ca ( OH )}_{2} + {CO}_{2} \to {CaCO}_{3} + {H}_{2} O & 0.59 {gCO}_{2} / g\end{matrix} \qquad Eq . 6$$

$$\begin{matrix}\begin{matrix}3 CaO \cdot {Al}_{2} {O}_{3} \cdot 3 {CaSO}_{4} \cdot 34 {H}_{2} O + 3 {CO}_{2} \to 3 {CaCO}_{3} + \\ 3 {CaSO}_{4} \cdot 2 {H}_{2} O + 2 {Al ( OH )}_{3} + 9 {H}_{2} O\end{matrix} & 0.04 {gCO}_{2} / g\end{matrix} \qquad Eq . 7$$

The C—S—H ranges in composition based on the Ca/Si ratio in the cement mixture. For cement-only formulations a Ca/Si of 1.5-1.8 is commonly observed, however, this decreases if Si-rich cement replacement materials are used (e.g., slag, metakaolin, fly ash, etc.) Complete carbonation of this phase results in the formation of CaCO₃ and silica gel (Eq. 4) after complete decalcification of the C—S—H. Partial carbonation of C—S—H (e.g., 0.093 gCO₂/g C—S—H) results in the formation of calcite crystals integrated within an enveloping amorphous structure (Eq. 5). This Ca/Si ratio also effects the maximum CO₂ uptake capacity as higher Ca contents lead to greater CaCO₃ formation.

Complete ettringite carbonation results in the formation of calcite, gypsum, aluminum hydroxide and water (Eq. 7). Complete conversion is accelerated and enhanced at higher temperatures of 75° C. where ettringite stability is known to decrease. Partial carbonation of ettringite results in a carbonate and sulfate solid solution as the CO₃²⁻ anions replace the SO₄²⁻ ions within the interlayer space.

Thermodynamic computations were performed using the Gibbs Energy Minimization Software for Geochemical Modelling (GEM-Selektor v.3.6). By considering the bulk elemental composition of a chemical system, GEMS computes the equilibrium phase assemblage using the Slop98.dat and Cemdata 18 database. Geochemical modelling has been used extensively to evaluate the effect of precursor composition on the hydrate phase assemblage. Geochemical modelling couples' solid phase thermodynamic databases with aqueous solution modelling. The Gibbs energy of the system is minimized to determine the solid-phase assemblage at equilibrium. The activity of the aqueous species was determined within GEMS for this study using the Truesdell-Jones modification of the extended Debye-Hückel equation that is applicable for ionic strengths (I, mol/L) less than 2 mol/L (Eq. 8):

$$log {γ}_{i} = \frac{- {Az}_{i}^{2} \sqrt{I}}{1 + \dot{a} B \sqrt{I}} + {b}_{γ} I + log \frac{{X}_{jw}}{{X}_{w}} \qquad Eq . 8$$

where, γᵢ and zᵢ are the activity coefficient and charge of the i^{th} aqueous species respectively, A and B are temperatures- and pressure-dependent coefficients, I is the molar ionic strength, X_{jw} is the molar quantity of water, and X_{w} is the total molar amount of the aqueous phase. A common ion size parameter, \dot{α}(3.31 Å) and short-range interaction parameter, by (0.098 kg·mol⁻¹), were used as constants for the NaOH background electrolyte. The NaOH electrolyte was used based on the higher pH observed in cementitious systems.

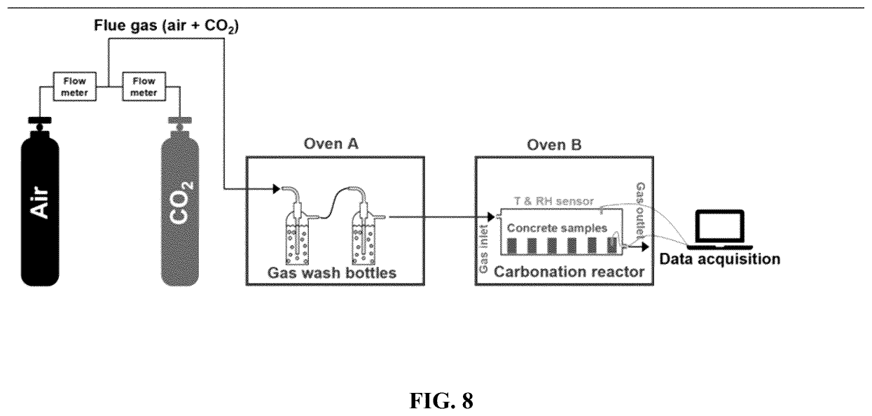

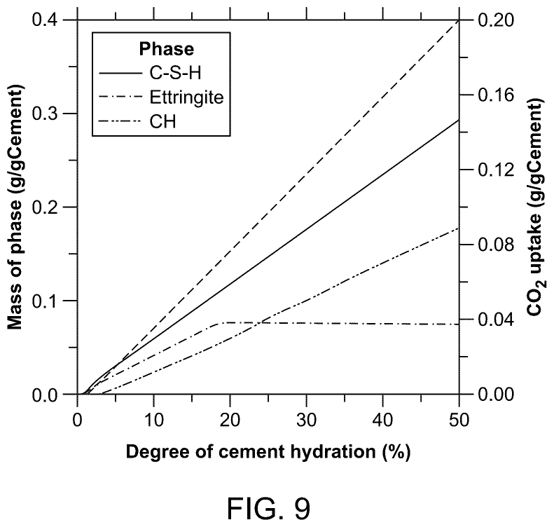

Thermodynamic modeling using the degree of hydration of the Type-III cement shown in FIG. 9 shows the increase of portlandite and C—S—H with an increasing degree of hydration. The ettringite content stabilizes at approximately 19.5% degree of hydration according to the simulations. As such it is possible to calculate a maximum uptake value based on the complete conversion of the phases: CH-0.59gCO₂/g_{solid}, ettringite-0.035 gCO₂/g_{solid}, and CSH-0.23-0.40 gCO₂/g_{solid}. The values for C—S—H are a range based on the Ca/Si of the C—S—H forming. Based on the mass fractions of the hydrates, the maximum CO₂ uptake of the cement was calculated to be 0.19 gCO₂/g_{Cement} after 24 hour of hydration at 25° C. This value was used as the basis for the total maximum conversion value for the cement component.

### Part Three: Gas Processing

The properties and composition of the input gas greatly affect CO₂ uptake and the energy demand of the carbonation step. Based on the input gas attributes shown in Table 6, the carbonation step was analyzed considering a single-pass process. To simulate the effect of the flue gas source on CO₂ uptake and unit duties, a single pass system considering: 2<[CO₂]<15 v./v.%, 2<[H₂O]<20 v./v.%, N₂ was used to complete molar volume balance, and 25<T<70° C. was used. Oxygen was not included as it is inert in this process. A fixed flue gas inlet flowrate of 1000 kg/h, a chiller set temperature of 15° C., and a heater set temperature of 65° C. were selected. The chiller and heater settings were chosen to reduce the water content and RH within the reactor.

TABLE 6
Ranges of N₂, CO₂, H₂O, and O₂ concentrations (v./v. %) in coal,
natural gas, and biomass combustion flue gases. The fuel source,
combustion efficiency, and post-treatment process (e.g., gas
scrubbing) affect the composition of the flue gases.

| | Coal | Natural Gas | Biomass |
|---|---|---|---|
| Component | (v./v. %) | (v./v. %) | (v./v. %) |
| N₂ | 75-80 | 67-80 | 71-75 |
| CO₂ | 12-14 | 3-10 | 12-14 |
| H₂O | 5-14 | 7-20 | 3-5 |
| O₂ | 2-4 | 2-15 | 3-6 |

Based on the chiller and heater settings, the temperature and RH of the flue gas remained fixed at ˜47° C. and ˜10.95% RH. A consequence of the fixed reactor conditions is that CO₂ uptake is dictated predominantly by the reactor [CO₂]. As moisture from the inlet stream is removed, the dry-gas CO₂ concentration increases thus enhancing the CO₂ uptake. CO₂ uptake ranged between 15.4<CO₂ uptake<36.2 kgCO₂/tonne concrete for a 24 h carbonation cycle. As shown by the regression model, CO₂ uptake is enhanced by the [CO₂] and is not substantially affected by the [H₂O] in the gas feed. However, the conversion of the CO₂ contained in the gas inlet stream is improved at lower [CO₂] levels in the reactor ranging between 0.05<Xₘ<0.18.

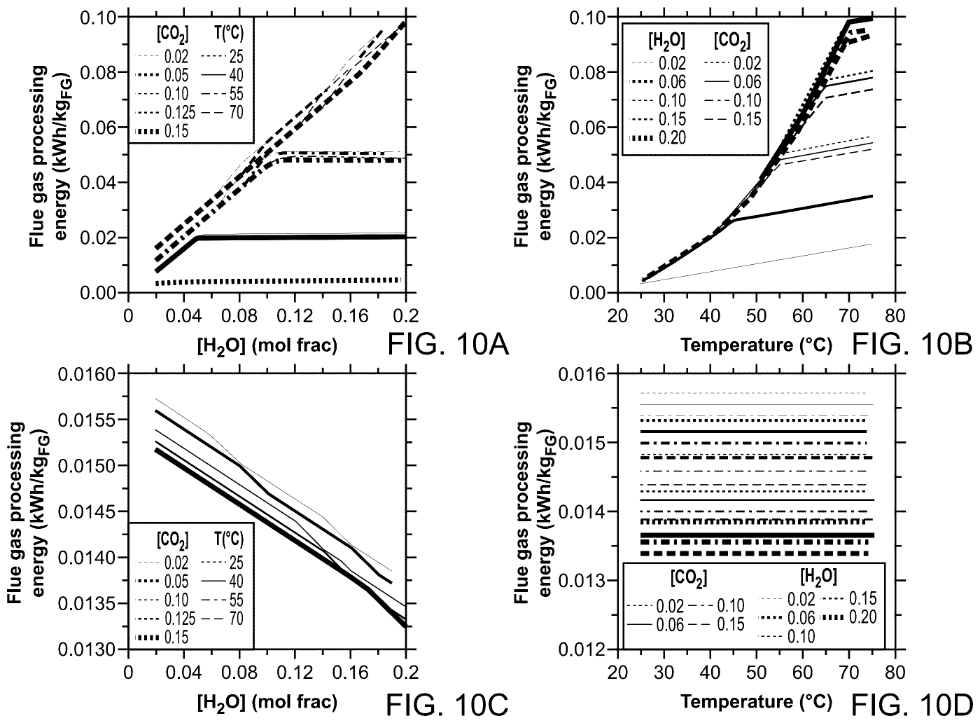

To achieve fixed reactor inlet conditions, the energy requirements of the heater and chiller vary significantly. The chiller duty was dictated by the inlet flue gas composition and temperature, impacting the energy requirements as shown in FIG. 10 (parts a-b), respectively. The variation of chiller duty depending on the flue gas composition and temperature results in a variation of energy usage per mass of flue gas treated ranging between 0.003-to-0.10 kWh/kg_{FG}. This variation is on account of the higher heat capacity of water-containing streams thus increasing the energy requirements. This affects the energy balance required to condense moisture from the gas stream according to the equation,

$$Q = {\dot{m}}_{x} {C p}_{y} ( {T}_{out} - {T}_{in} ) + {\dot{m}}_{x} {ΔH}_{c , vap} \qquad Eq . 9$$

where \dot{m}ₓ is the mass flow rate in kg/h, Cp_{y} is the specific heat capacity in kJ/kg° C., T_{c,in} is the inlet temperature in ° C., Tₒᵤₜ is the outlet temperature in ° C., ΔHᵥₐₚ is the latent heat of vaporization in kJ/kg, and subscript c denotes the stream entering the chiller. As the Cp_{y} and ΔHᵥₐₚ increase with water content, the energy required to decrease the incoming flue gas temperature increases. In addition, the influence of the incoming flue gas's temperature impacts the chiller duty significantly as shown in FIG. 10b due to the increasing temperature difference between the inlet and outlet streams.

The range of the heater energy requirements was lower than the chiller (0.013-to-0.015 kWh/kg_{FG}) as the temperature of the gas stream entering the heater remained constant (FIGS. 10c and 10d)). It must be noted that the duty required by the fans remained relatively fixed throughout the simulations and the main fluctuations were the result of the chiller duty.

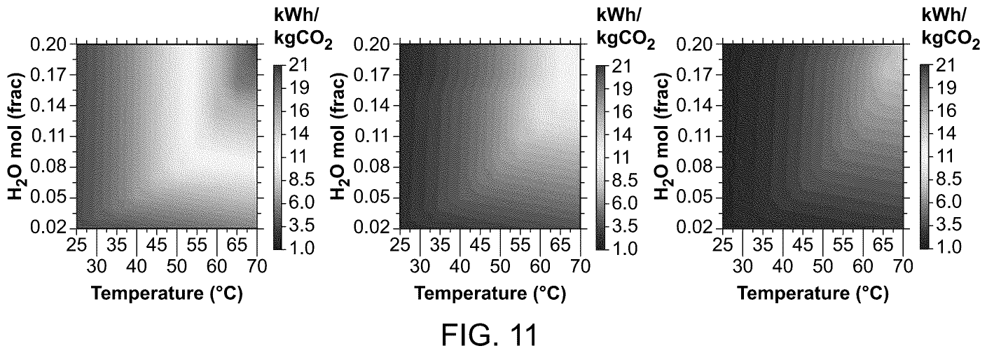

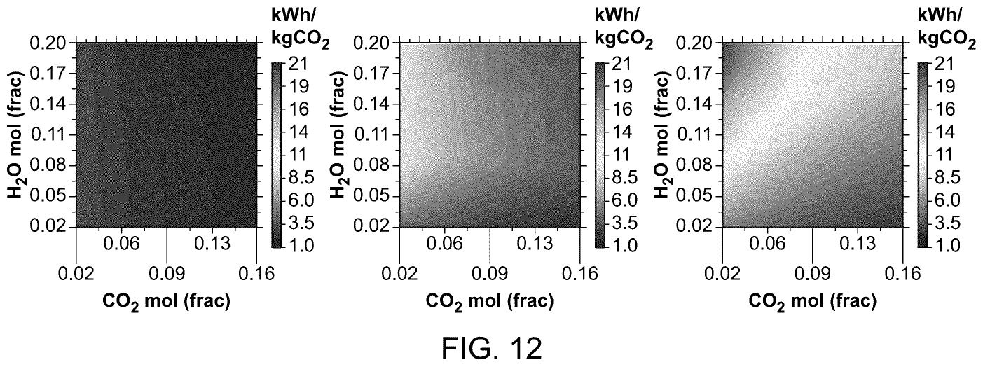

The energy required to sequester a mass of CO₂ in the concrete was dependent on the flue gas inlet conditions resulting in energy intensities ranging from 1.4-to-20.9 kWh/kgCO₂. FIG. 11a-c) identify that increasing the temperature of the inlet flue gas linearly increases the energy required to sequester CO₂ and is a dominant factor as the chiller energy requirements dominate the total energy. The maximum heater energy is recorded at 0.015 kWh/kg which is equivalent to the minimum chiller energy requirements for cooling the incoming flue gas at approximately 40° C. Past this point, the chiller energy requirements can be up to 6.3 times higher. Therefore, the cooling requirement of the inlet flue gas is a key factor to consider. To mitigate the energy requirements of the chiller, a heat exchanger could be used to mitigate the cooling requirements. As for the composition of the inlet flue gas, increasing [CO₂] while decreasing [H₂O] are ideal (FIG. 12a-c)). The increased CO₂ uptake from the higher [CO₂] stream and the reduced energy requirements due to the reduced condensing requirements show that energy efficiencies can vary up to a factor of 14.9 times.

Total CO₂ uptake dependent on the recycle ratio, chiller and heater conditions indicated that low recycles ratio (RR), low chiller and high heater conditions are ideal for CO₂ uptake.

The high heater and low chiller conditions caused the greatest gas processing energy requirements due to the highest ΔT from the inlet and outlet of the incoming gas. The lower recycle ratio required the greatest gas processing energy due to the additional water in the gas feed that required condensing. The heater would require a lower duty due to the lower mass flowrate entering once the excess water is removed. However, the chiller still dominated the energy requirements.

Although the chiller and heater duties are higher for the low recycle ratios, the greater CO₂ uptake caused a lower energy intensity compared to the higher recycle ratios.

The embodiments and examples described above are intended to be merely illustrative and non-limiting. Those skilled in the art will recognize or will be able to ascertain using no more than routine experimentation, numerous equivalents of systems, processes, and procedures herein. All such equivalents are considered to be within the scope and are encompassed by the appended claims. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure. It should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto.

1. A process comprising:
flowing a CO₂-containing gas from a gas conditioning apparatus into a carbonation chamber comprising at least one green body;
measuring, in real-time, temperature, relative humidity, CO₂ concentration, gas flow rate, gas flow direction, or a combination thereof, in the carbonation chamber to provide a measurement;
inputting the measurement into a model to determine the extent of carbonation of the at least one green body;
sending a control signal to the gas conditioning apparatus while flowing the CO₂-containing gas to:
actively condition the CO₂-containing gas based on the extent of carbonation; and
effect a multi-step carbonation process.

2. The process of claim 1, wherein measuring further comprises measuring, in real-time, temperature, relative humidity, CO₂ concentration, gas flow rate, gas flow direction, or a combination thereof, in the at least one green body in the carbonation chamber.

3. The process of claim 1, further comprising sending a control signal to the gas conditioning apparatus while flowing the CO₂-containing gas to reduce process energy.

4. (canceled)

5. The process of claim 1, comprising sending a control signal to the gas conditioning apparatus while flowing the CO₂-containing gas to maintain a carbonation rate above 0.005/sec.

6. (canceled)

7. The process of claim 1, wherein actively conditioning the CO₂-containing gas comprises altering the temperature, relative humidity, CO₂ concentration, gas flow rate, gas flow direction, or a combination thereof, using at least two more steps.

8. (canceled)

9. The process of claim 1, comprising actively adjusting the temperature, relative humidity, CO₂ concentration, gas flow rate, gas direction, or combinations thereof, in the carbonation chamber.

10. (canceled)

11. (canceled)

12. (canceled)

13. (canceled)

14. (canceled)

15. (canceled)

16. The process of claim 9, wherein the actively adjusting is based on real-time data selected from temperature, humidity, CO₂ concentration, flow rate, flow direction, or a combination thereof, in the carbonation chamber.

17. The process of claim 9, wherein the actively adjusting is based on real-time data selected from temperature, relative humidity, moisture content or a combination thereof, in at least one green body.

18. (canceled)

19. The process of claim 1, further comprising initiating the process with conditioned dry and hot CO₂ gas stream to adjust the moisture content of the at least one green body until a desired relative humidity of the concrete is achieved in the chamber; curing the at least one green body or at least one concrete component; and flowing cooler and/or more humid CO₂ gas stream to re-introduce water into the concrete to continue carbonation and hydration reactions.

20. The process of claim 1, further comprising air curing for 0 to 12 hours before flowing conditioned CO₂ gas stream in the flow-through chamber.

21. The process of claim 1, wherein the at least one green body has a temperature at or above 30° C., a relative humidity lower than 95%, or both.

22. (canceled)

23. The process of claim 1, further comprising flowing conditioned CO₂ gas stream in the flow-through chamber which has a relative humidity between 10%-50%.

24. The process of claim 1, further comprising flowing conditioned CO₂ gas stream in the flow-through chamber which has a relative humidity between 10%-50% until internal temperature of the at least one green body reaches above 30° C.

25. The process of claim 1, further comprising flowing conditioned gas in the flow-through chamber with temperature between 20° C.-80° C., relative humidity of 10%-90%, or both.

26. (canceled)

27. The process of claim 1, further comprising using waste heat to heat the CO₂-containing gas to about 20° C. to about 80° C. before the CO₂-containing gas enters the flow-through chamber.

28. (canceled)

29. (canceled)

30. A carbonated green body made by the process of claim 1.

31. A system comprising:
a gas conditioning apparatus;
a flow-through chamber; and
an instrument configured to send control signals to the gas conditioning apparatus wherein the flow-through chamber is at atmospheric pressure and comprises; and a processor configured to receive real-time measurements and a storage medium with instructions operable when executed for:
flowing a CO₂-containing gas from a gas conditioning apparatus into a carbonation chamber comprising at least one green body;
measuring, in real-time, temperature, relative humidity, CO₂ concentration, gas flow rate, gas flow direction, or a combination thereof, in the carbonation chamber to provide a measurement;
inputting the measurement into a model to determine the extent of carbonation of the at least one green body; and
sending a control signal to the gas conditioning apparatus while flowing the CO₂-containing gas to:
actively condition the CO₂-containing gas based on the extent of carbonation; and
effect a multi-step carbonation process.

32. The system of claim 31, wherein the instrument is configured to send control signals to the gas conditioning apparatus to adjust actively temperature, relative humidity, CO₂ concentration, gas velocity, or combinations thereof, in a CO₂-containing gas moving through the gas conditioning apparatus.

33. (canceled)

34. The system of claim 31, wherein the temperature of the CO₂-containing gas stream in the flow-through chamber is higher than the temperature of the at least one green body.

35. (canceled)

36. (canceled)

37. (canceled)

38. (canceled)

39. (canceled)

40. (canceled)

41. (canceled)

42. The system of claim 31, wherein the at least one green body comprises at least one member selected from the group consisting of hydrated lime, portland cement, coal combustion residues, recycled concrete aggregates, natural pozzolans, other industrial solid wastes, or a combination thereof.

43. (canceled)
